(19) United States
(12) Patent Application Publication
(10) Pub. No.: US 2015/0185523 A1
(43) Pub. Date: Jul. 2, 2015

(54) LIGHT MODULATION METHOD, LIGHT MODULATION PROGRAM, LIGHT MODULATION DEVICE, AND ILLUMINATION DEVICE

(71) Applicant: HAMAMATSU PHOTONICS K.K., Hamamatsu-shi, Shizuoka (JP)

(72) Inventors: Naoya Matsumoto, Hamamatsu-shi (JP); Takashi Inoue, Hamamatsu-shi (JP); Yuu Takiguchi, Hamamatsu-shi (JP)

(73) Assignee: HAMAMATSU PHOTONICS K.K., Hamamatsu-shi, Shizuoka (JP)

(21) Appl. No.: 14/416,705

(22) PCT Filed: Jul. 9, 2013
(86) PCT No.: PCT/JP2013/068742

§ 371 Date: Jan. 23, 2015

(30) Foreign Application Priority Data
Jul. 26, 2012 (JP) 2012-165722

(51) Int. Cl. G02F 1/133; G02F 1/13

(52) U.S. Cl. CPC G02F 1/13306; G02F 1/1313

(57) ABSTRACT

A light modulation device includes a phase-modulation type spatial light modulator having a plurality of two-dimensionally arrayed pixels and modulating a phase of input light for each pixel with a modulation pattern, a modulation pattern setting unit setting a target modulation pattern for modulating the phase of the light, a correction coefficient setting unit setting a correction coefficient α of α≧1 according to pixel structure characteristics of the spatial light modulator and pattern characteristics of the target modulation pattern, and a modulation pattern correction unit determining a corrected modulation pattern to be presented on the plurality of pixels of the spatial light modulator by multiplying the target modulation pattern by the correction coefficient α.

### TECHNICAL FIELD

The present invention relates to a light modulation method, a light modulation program, a light modulation device, and a light irradiation device using the same, which modulate a phase of light such as laser light with a modulation pattern presented on a plurality of pixels of a spatial light modulator.

### BACKGROUND ART

A spatial light modulator (SLM: Spatial Light Modulator) is an optical device used for control of light. In particular, a phase-modulation type spatial light modulator is to modulate a phase of input light, and output phase-modulated light, and is capable of not modulating an amplitude, and changing only a phase of the input light, to output the light (refer to, for example, Patent Document 1, and Non-Patent Documents 1 to 5).

As one of the features of this phase-modulation type SLM, it is included that it is possible to shape its wave front by modulating a phase of light, so as to generate multispot light condensing points having different spatial positions from a single light source and at temporally same timing. By use of multispot simultaneous irradiation of light with a multispot pattern generated by a phase-modulation type SLM, it is possible to execute, for example, simultaneous processing at a plurality of positions in laser processing, simultaneous observation of a plurality of positions in the purpose of a laser scanning microscope, and the like without loss of light amount.

As an example of utilization of a phase-modulation type SLM, a case where a multispot irradiation pattern with 10 points is generated by performing phase modulation onto laser light supplied from a single laser light source by the SLM, to perform multispot simultaneous processing of a processing object by use of this irradiation pattern will be considered. In this case, as compared with the conventional laser processing using only one light condensing point by a laser light source, there is the advantage that a processing speed for an object increases tenfold by use of the phase-modulation type SLM.

### CITATION LIST

### Patent Literature

Patent Document 1: Japanese Patent Application Laid-Open No. 2010-075997

### Non Patent Literature

Non-Patent Document 1: R. W. Gerchberg et al., “A practical algorithm for the determination of phase from image and diffraction plane pictures,” Optik Vol. 35 (1972) pp. 237-246
Non-Patent Document 2: D. Prongue et al., “Optimized kinoform structures for highly efficient fan-out elements,” Appl. Opt. Vol. 31 No. 26 (1992) pp. 5706-5711
Non-Patent Document 3: O. Ripoll et al., “Review of iterative Fourier-transform algorithms for beam shaping applications,” Opt. Eng. Vol. 43 No. 11 (2004) pp. 2549-2556
Non-Patent Document 4: J. Bengtsson, “Kinoform design with an optimal-rotation-angle method,” Appl. Opt. Vol. 33 No. 29 (1994) pp. 6879-6884
Non-Patent Document 5: D. Palima et al., “Holographic projection of arbitrary light patterns with a suppressed zero-order beam,” Appl. Opt. Vol. 46 No. 20 (2007) pp. 4197-4201

### SUMMARY OF INVENTION

### Technical Problem

In a phase-modulation type SLM, there are advantages that it is possible to achieve speed-up of laser processing, etc., by parallel processing utilizing multispot simultaneous irradiation as described above, and the like. On the other hand, in laser light irradiation performed by use of an SLM in this way, in addition to a desired irradiation pattern due to phase-modulated laser light output from the SLM, unexpected laser light irradiation due to undesired zeroth-order light generated by the SLM may become a problem in some cases.

Here, undesired zeroth-order light is basically generated by a light component which is not modulated in the SLM. Such a light component is condensed as unexpected light on a focal position on which a plane wave is condensed by a lens in the case, for example, where the lens is disposed at the subsequent stage of the SLM. When such undesired zeroth-order light is generated, in the case where laser light modulated by a phase-modulation type SLM is utilized, the problems such as, for example, causing unexpected processing onto an object other than a planned processing point in laser processing, variation and deterioration of the observation conditions for an object due to the influence of the undesired zeroth-order light in a laser scanning microscope, and the like are caused.

The present invention has been achieved in order to solve the above-described problem, and an object thereof is to provide a light modulation method, a light modulation program, a light modulation device, and a light irradiation device which are capable of suppressing the generation of undesired zeroth-order light by an SLM.

### Solution to Problem

In order to achieve the above-described object, a light modulation method according to the present invention, (1) which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation method includes (2) a modulation pattern setting step of setting a target modulation pattern for modulating the phase of the light in the spatial light modulator, (3) a correction coefficient setting step of setting a correction coefficient α of α≧1 according to pixel structure characteristics of the spatial light modulator and pattern characteristics of the target modulation pattern, for the target modulation pattern, (4) a modulation pattern correction step of determining a corrected modulation pattern to be presented on the plurality of pixels of the spatial light modulator by multiplying the target modulation pattern by the correction coefficient α, and (5) a modulation pattern presentation step of presenting the corrected modulation pattern on the plurality of pixels of the spatial light modulator.

A light modulation program according to the present invention, (1) which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation program makes a computer execute (2) modulation pattern setting processing of setting a target modulation pattern for modulating the phase of the light in the spatial light modulator, (3) correction coefficient setting processing of setting a correction coefficient α of α≧1 according to pixel structure characteristics of the spatial light modulator and pattern characteristics of the target modulation pattern, for the target modulation pattern, (4) modulation pattern correction processing of determining a corrected modulation pattern to be presented on the plurality of pixels of the spatial light modulator by multiplying the target modulation pattern by the correction coefficient α, and (5) modulation pattern presentation processing of presenting the corrected modulation pattern on the plurality of pixels of the spatial light modulator.

A light modulation device according to the present invention includes (a) a phase-modulation type spatial light modulator having a plurality of two-dimensionally arrayed pixels, modulating a phase of input light for each pixel with a modulation pattern presented on the plurality of pixels, and outputting phase-modulated light, (b) modulation pattern setting means setting a target modulation pattern for modulating the phase of the light in the spatial light modulator, (c) correction coefficient setting means setting a correction coefficient α of α≧1 according to pixel structure characteristics of the spatial light modulator and pattern characteristics of the target modulation pattern, for the target modulation pattern, and (d) modulation pattern correction means determining a corrected modulation pattern to be presented on the plurality of pixels of the spatial light modulator by multiplying the target modulation pattern by the correction coefficient α.

In the light modulation method, the light modulation program, and the light modulation device described above, with respect to the phase modulation patterns to be presented on the spatial light modulator, a target modulation pattern is set so as to correspond to a desired irradiation pattern or the like of light such as laser light. Then, with respect to the phase modulation of light which is actually executed in the spatial light modulator with this target modulation pattern, the two-dimensional pixel structure characteristics of the plurality of pixels in the spatial light modulator, and the pattern characteristics of the target modulation pattern are focused, and a correction coefficient α of 1 or more (α≧1) is set according to these pixel structure characteristics and pattern characteristics. In accordance with such a configuration, a corrected modulation pattern generated by multiplying the target modulation pattern by the correction coefficient α is presented on the plurality of pixels of the spatial light modulator, thereby it is possible to suppress the generation of undesired zeroth-order light in phase modulation of light in the spatial light modulator.

A light irradiation device according to the present invention includes a light source which supplies light serving as a modulation object, and a light modulation device having the above-described configuration including a phase-modulation type spatial light modulator which modulates a phase of the light supplied from the light source, and outputs the phase-modulated light. Further, in the case where the light serving as a modulation object is laser light, a laser light irradiation device includes a laser light source which supplies laser light, and a light modulation device having the above-described configuration including a phase-modulation type spatial light modulator which modulates a phase of the laser light supplied from the laser light source, and outputs the phase-modulated laser light.

In accordance with such a configuration, in the light modulation device including the phase-modulation type spatial light modulator, a modulation pattern corrected by multiplying the target modulation pattern by the correction coefficient α is presented on the plurality of pixels of the spatial light modulator, thereby it is possible to suppress the generation of undesired zeroth-order light in phase modulation of light, and it is possible to appropriately achieve operations such as irradiation of light onto an object with a desired irradiation pattern, and processing, observation, etc. of the object by irradiation. Such a light irradiation device is available as, for example, a laser processing device, a laser microscope, a laser manipulation device, or as an aberration correction device for a laser scanning ophthalmoscope or the like.

### Advantageous Effects of Invention

In accordance with the light modulation method, the light modulation program, the light modulation device, and the light irradiation device using the same of the present invention, a target modulation pattern is set with respect to a modulation pattern to be presented on the spatial light modulator, and a correction coefficient α of 1 or more is set according to the pixel structure characteristics of the plurality of pixels in the spatial light modulator, and the pattern characteristics of the target modulation pattern, and a modulation pattern corrected by multiplying the target modulation pattern by the correction coefficient α is presented on the spatial light modulator, thereby it is possible to inhibit the generation of undesired zeroth-order light in phase modulation of light in the spatial light modulator.

### BRIEF DESCRIPTION OF DRAWINGS

FIG. 1 is a diagram showing a configuration of one embodiment of a laser light irradiation device which is a light irradiation device including a light modulation device.

FIG. 2 includes diagrams showing an example of a configuration of a phase-modulation type spatial light modulator.

FIG. 3 is a block diagram showing an example of a configuration of the light modulation device.

FIG. 4 includes diagrams showing the generation of undesired zeroth-order light in a reconstructed pattern of phase-modulated laser light by the spatial light modulator.

FIG. 5 includes diagrams showing the influence of a pixel gap in phase modulation of laser light by the spatial light modulator.

FIG. 6 is a graph showing changes in diffraction efficiency of zeroth-order light according to a correction coefficient α.

FIG. 7 is a diagram showing a rectangular multispot reconstructed pattern with 2×2 points.

FIG. 8 is a diagram showing a rectangular multispot reconstructed pattern with 16×16 points.

FIG. 9 is a diagram showing a rectangular multispot reconstructed pattern with 32×32 points.

FIG. 10 is a graph showing changes in diffraction efficiency of zeroth-order light according to a correction coefficient α.

FIG. 11 is a diagram showing a rectangular multispot reconstructed pattern with 20×20 points.

FIG. 12 is a diagram showing a rectangular multispot reconstructed pattern with 10×10 points.

FIG. 13 is a diagram showing a rectangular multispot reconstructed pattern with 2×2 points.

FIG. 14 is a graph showing changes in diffraction efficiency of zeroth-order light according to a correction coefficient α.

FIG. 15 is a diagram showing an example of an evaluation optical system used for derivation of a correction coefficient α.

FIG. 16 is a flowchart showing an example of a method of setting a correction coefficient α.

FIG. 17 is a flowchart showing another example of the method of setting a correction coefficient α.

FIG. 18 is a flowchart showing yet another example of the method of setting a correction coefficient α.

FIG. 19 is a diagram showing an example of a look up table showing the correspondence relationship between target modulation patterns and correction coefficients α.

FIG. 20 is a diagram showing a reconstruction result of a rectangular multispot pattern with 8×8 points.

FIG. 21 is a diagram showing a reconstruction result of a rectangular multispot pattern with 8×8 points.

FIG. 22 includes graphs showing the intensity profiles of zeroth-order light in the reconstruction results shown in FIGS. 20, 21.

FIG. 23 includes diagrams showing reconstruction results of a cylindrical lens pattern.

FIG. 24 is a graph showing the intensity profiles of zeroth-order light in the reconstruction results shown in FIG. 23.

### DESCRIPTION OF EMBODIMENTS

Hereinafter, embodiments of a light modulation method, a light modulation program, a light modulation device, and a light irradiation device according to the present invention will be described in detail with reference to the drawings. In addition, in the description of the drawings, the same components are denoted by the same reference symbols, and overlapping descriptions thereof will be omitted. Further, the dimensional ratios in the drawings are not necessarily matched to those in the description.

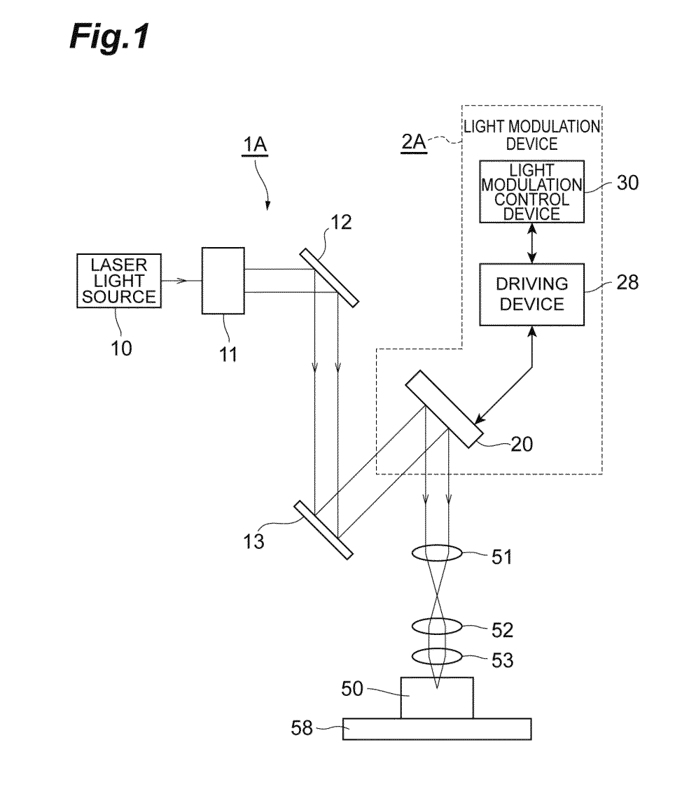

First, the basic configurations of a light modulation device and a light irradiation device including the light modulation device according to the present invention will be described along with their configuration examples. Here, the descriptions are made below assuming mainly laser light as light serving as a modulation object by a spatial light modulator. However, the light serving as a modulation object is not limited to laser light. FIG. 1 is a diagram showing a configuration of one embodiment of a laser light irradiation device which is a light irradiation device including a light modulation device. A laser light irradiation device 1A according to the present embodiment is a device which performs light condensing irradiation of laser light onto an irradiation object 50 with a desired irradiation pattern, and includes a laser light source 10, a light modulation device 2A, and a movable stage 58.

In the configuration shown in FIG. 1, the irradiation object 50 is placed on the movable stage 58 which is configured to move in an X-direction and a Y-direction (horizontal directions), and a Z-direction (vertical direction). Further, in the irradiation device 1A, for example, a one-point or multispot light condensing point for performing processing, observation, or the like of the object 50 is set on its surface, or the inside of the irradiation object 50, and light condensing irradiation of laser light is performed onto the light condensing point.

The laser light source 10 is laser light supply means for supplying laser light such as pulsed laser light for irradiating the object 50 on the stage 58. The laser light output from the laser light source 10 is expanded by a beam expander 11, and is thereafter input to the light modulation device 2A including a spatial light modulator (SLM) 20 via reflecting mirrors 12 and 13.

The light modulation device 2A according to the present embodiment includes the spatial light modulator 20, a light modulator driving device 28, and a light modulation control device 30. The SLM 20 is a phase-modulation type spatial light modulator having a plurality of two-dimensionally arrayed pixels, and modulates a phase of input laser light for each pixel with a two-dimensional modulation pattern presented on the plurality of pixels, and outputs the phase-modulated laser light. In such a configuration, for example, a phase modulation pattern such as a hologram (CGH: Computer Generated Hologram) which is determined by a numerical calculation is presented on the SLM 20, and with this modulation pattern, light condensing irradiation of the laser light onto a set light condensing point is controlled.

Further, the spatial light modulator 20 is drive-controlled by the light modulation control device 30 via the driving device 28. The control device 30 performs generation and storage of a CGH to be presented on the SLM 20, transmission of a necessary signal to the driving device 28, and the like. Further, the driving device 28 converts the signal of the CGH transmitted from the control device 30 into a voltage instruction value with reference to a LUT (Look Up Table), and then performs an instruction to apply a voltage to the SLM 20. The LUT used here is, for example, a reference table which is used at the time of converting an input signal from the control device 30 corresponding to a phase value into a voltage instruction value in order to correct a nonlinear response, etc., to a voltage that a liquid crystal used for the SLM 20 has. In addition, the detailed configuration and the like of the light modulation device 2A including the SLM 20, the driving device 28, and the control device 30 will be described later.

This spatial light modulator 20 may be a reflective type, or may be a transmissive type. FIG. 1 shows a reflective type one as the spatial light modulator 20. Further, as the spatial light modulator 20 having a two-dimensional pixel structure, for example, a refractive-index changing material type SLM (for example, as an SLM using a liquid crystal, an LCOS (Liquid Crystal on Silicon) type, and an LCD (Liquid Crystal Display)) may be cited.

The laser light which is phase-modulated into a predetermined pattern in the spatial light modulator 20, to be output is propagated to an objective lens 53 by a 4f optical system composed of lenses 51 and 52. Then, a single light condensing point or a plurality of light condensing points which are set on the surface or the inside of the irradiation object 50 are irradiated with the laser light by this objective lens 53.

In addition, the configuration of the optical system in the laser light irradiation device 1A is specifically not limited to the configuration shown in FIG. 1, and various configurations may be used. For example, in FIG. 1, the configuration is made such that laser light is expanded by the beam expander 11, meanwhile, the configuration may be made so as to use a combination of a spatial filter and a collimator lens. Further, in the light modulation device 2A, the driving device 28 may be provided integrally with the SLM 20. Further, as the 4f optical system composed of the lenses 51 and 52, in general, a both-sided telecentric optical system composed of a plurality of lenses is preferably used.

Further, the movable stage 58 which moves the irradiation object 50 may be configured, for example, such that this stage is a fixed stage, or a movable stage moving in only an optical axis direction, and a movable mechanism, a Galvano mirror, or the like may be provided on the optical system side. Further, as the laser light source 10, a pulsed laser light source, for example, such as Nd:YAG laser light source, a femtosecond laser light source, which supplies pulsed laser light is preferably used.

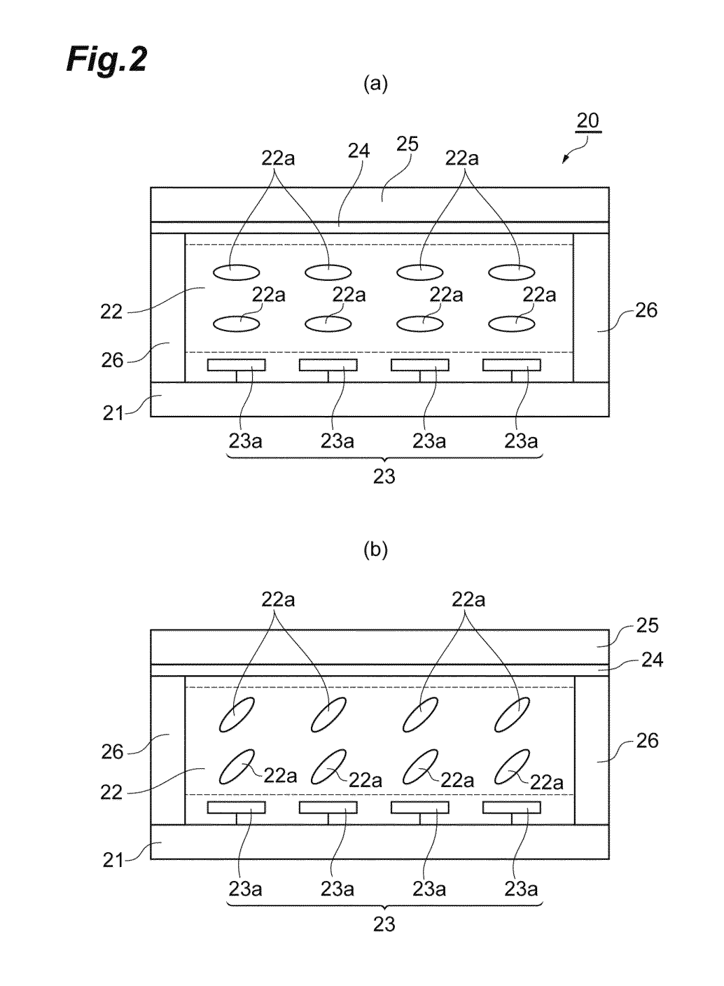

The configuration of the phase-modulation type spatial light modulator 20 used in the laser light irradiation device 1A and the light modulation device 2A shown in FIG. 1 will be described. FIG. 2 includes diagrams showing the configuration of an LCOS-SLM as an example of a configuration of a phase-modulation type spatial light modulator. In FIG. 2, (a) in FIG. 2 is a side cross-sectional view schematically showing a part of the configuration of the SLM 20, and (b) in FIG. 2 is a side cross-sectional view schematically showing the part of the configuration of the SLM 20 in a state in which its liquid crystal molecules are rotated.

In this configuration example, the SLM 20 has a silicon substrate 21, and a liquid crystal layer 22 provided on the silicon substrate 21. Further, the SLM 20 further has a pixel electrode group 23 disposed between the silicon substrate 21 and the liquid crystal layer 22, and an electrode 24 which is provided at a position sandwiching the liquid crystal layer 22 with the pixel electrode group 23. The pixel electrode group 23 is composed of a plurality of pixel electrodes 23a for applying a voltage to the liquid crystal layer 22. These plurality of pixel electrodes 23a are two-dimensionally arrayed in a plurality of rows and a plurality of columns, thereby defining a two-dimensional pixel structure by a plurality of pixels composing the SLM 20.

On the other hand, the electrode 24 is, for example, formed of a metal film vapor-deposited on one surface of a glass substrate 25, and this metal film is optically transparent. The glass substrate 25 is supported on the silicon substrate 21 via a spacer 26 such that the above-described one surface of the substrate 25 and the silicon substrate 21 face each other. Further, the liquid phase layer 22 is configured so as to fill a liquid crystal between the silicon substrate 21 and the glass substrate 25.

In the SLM 20 including this configuration, an analog signal voltage for each pixel output from the driving device 28 is applied between the corresponding pixel electrode 23a and the electrode 24. Thereby, an electric field is generated in the liquid crystal layer 22 sandwiched between the pixel electrode group 23 and the electrode 24. Then, as shown in (b) in FIG. 2, the liquid crystal molecules 22a on the respective pixel electrodes 23a are rotated according to a level of the electric field applied. Because the liquid crystal molecules 22a have the birefringent property, when light is incident into those through the glass substrate 25, a phase difference according to the rotation of the liquid crystal molecules 22a is given to only a light component in this light, which is parallel to the orientation direction of the liquid crystal molecules 22a. In this way, a phase of input laser light is modulated for each of the pixel electrodes 23a.

Here, in the case where laser light irradiation is performed by use of the phase-modulation type SLM 20 having the plurality of two-dimensionally arrayed pixels as in the configuration example shown in FIG. 2, in addition to a desired irradiation pattern due to phase-modulated light output from the SLM 20, unexpected laser light irradiation due to undesired zeroth-order light generated by the SLM 20 may become a problem in some cases. Such undesired zeroth-order light is, as will be described in detail later, generated by a light component which is not modulated in the SLM 20 due to the pixel structure or the like of the SLM 20. In contrast, the light modulation device 2A shown in FIG. 1 is configured to design and correct a modulation pattern to be presented on the SLM 20 so as to suppress the generation of such undesired zeroth-order light by the SLM 20.

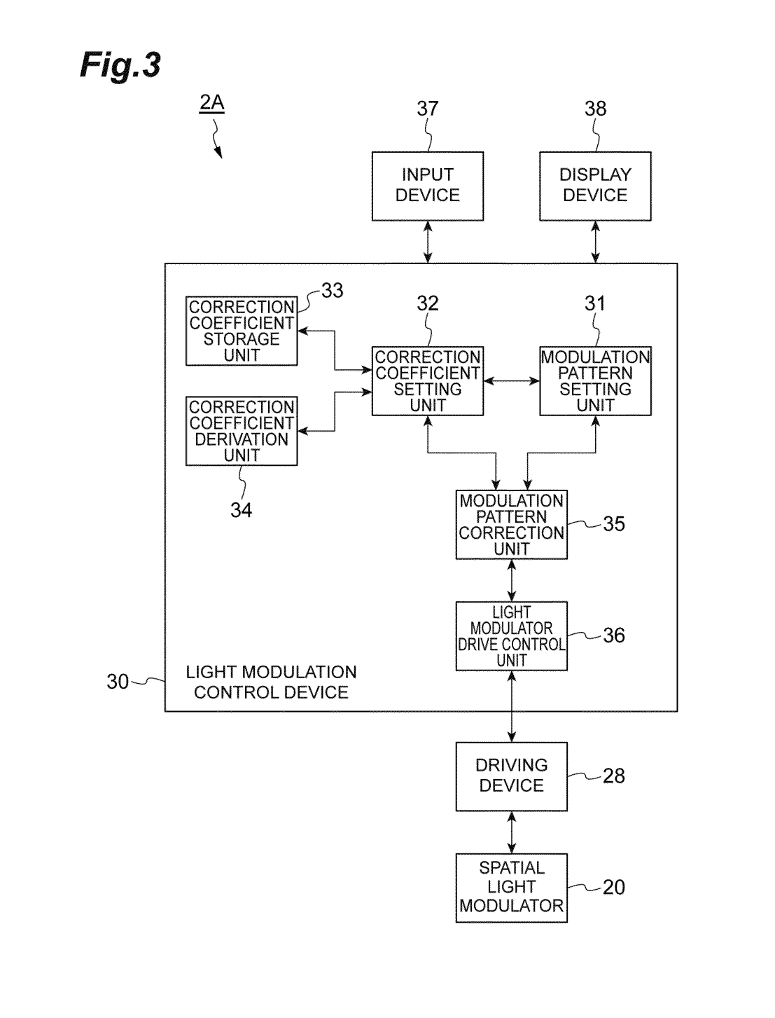

FIG. 3 is a block diagram showing an example of the configuration of the light modulation device 2A which is applied to the laser light irradiation device 1A shown in FIG. 1. The light modulation device 2A according to the present configuration example includes the spatial light modulator (SLM) 20, the light modulator driving device 28, and the light modulation control device 30 as shown in FIG. 1. Further, the control device 30 includes a modulation pattern setting unit 31, a correction coefficient setting unit 32, a modulation pattern correction unit 35, and a light modulator drive control unit 36.

In addition, in this configuration, the light modulation control device 30 in which design, correction, storage, and the like of a modulation pattern (CGH) are carried out may be composed of a computer, for example. Further, respective devices such as an input device 37 used for inputting information, instructions, and the like necessary for light modulation control, and a display device 38 used for displaying information for an operator are connected to this control device 30 as needed.

The modulation pattern setting unit 31 is modulation pattern setting means (a modulation pattern setting step) for setting a target modulation pattern for modulating a phase of laser light in the SLM 20 with respect to the SLM 20 having the plurality of pixels two-dimensionally arrayed. A CGH used as a target modulation pattern may be prepared, for example, by the design methods described in Non-Patent Documents 1 to 4 with reference to a desired reconstructed pattern in laser light irradiation, etc. The design of a CGH in the setting unit 31 using these methods is carried out under ideal conditions under which undesired zeroth-order light is not generated.

The correction coefficient setting unit 32 is correction coefficient setting means (a correction coefficient setting step) for setting a correction coefficient α of 1 or more (α≧1) according to the pixel structure characteristics of the SLM 20 (refer to FIG. 2) and the pattern characteristics of the target modulation pattern, for the target modulation pattern which is the ideal CGH designed in the modulation pattern setting unit 31. This correction coefficient α is set in order to suppress the generation of undesired zeroth-order light due to the pixel structure of the SLM 20.

Further, a correction coefficient storage unit 33 and a correction coefficient derivation unit 34 are provided for the correction coefficient setting unit 32. The correction coefficient storage unit 33 is storage means for storing a correction coefficient α which is determined in advance according to the pattern characteristics of the target modulation pattern so as to correspond to the target modulation pattern. Further, the correction coefficient derivation unit 34 is derivation means (a correction coefficient derivation step) for determining a correction coefficient α according to the pattern characteristics of the target modulation pattern with reference to the target modulation pattern. The setting unit 32 uses the storage unit 33 or the derivation unit 34 as needed, to acquire a correction coefficient α corresponding to a target modulation pattern.

The modulation pattern correction unit 35 is modulation pattern correction means (a modulation pattern correction step) for determining a corrected modulation pattern to be actually presented on the plurality of pixels of the SLM 20 by multiplying the target modulation pattern by the correction coefficient α. Here, given that a two-dimensional pixel position on a plane (modulation plane) perpendicular to an optical axis of each pixel composing the SLM 20 is (x, y), a target modulation pattern prepared in the setting unit 31 is φ_{CGH}(x, y), and a corrected modulation pattern in the correction unit 35 is φ_{SLM}(x, y), the corrected modulation pattern φ_{SLM} is determined as follows.

φ_{SLM}(x,y)=φ_{CGH}(x,y)×α

The light modulator drive control unit 36 is drive control means (a modulation pattern presentation step) which drive-controls the SLM 20 via the driving device 28, to present the corrected modulation pattern φ_{SLM} created by the modulation pattern correction unit 35, on the plurality of pixels of the SLM 20. This drive control unit 36 is provided as needed in accordance with the detailed configuration of the light modulation device 2A including the SLM 20, the driving device 28, and the control device 30.

It is possible to achieve processing corresponding to the light modulation method executed in the light modulation control device 30 shown in FIG. 3, by a light modulation program for making a computer execute light modulation control. For example, the control device 30 may be composed of a CPU which runs respective software programs necessary for processing of light modulation control, a ROM in which the above-described software programs and the like are stored, and a RAM in which data are temporarily stored during program execution. In this configuration, by executing a predetermined light modulation program by the CPU, it is possible to realize the light modulation device 2A including the control device 30 described above.

Further, the above-described program for causing the CPU to execute the respective processing for a laser light modulating operation by use of the SLM 20, in particular, for design and correction of a modulation pattern to be presented on the SLM 20 may be recorded on a computer-readable recording medium, to be distributed. As such a recording medium, for example, a magnetic medium such as a hard disk or a flexible disk, an optical medium such as a CD-ROM or a DVD-ROM, a magnetooptic medium such as a floptical disk, or a hardware device such as a RAM, a ROM, or a semiconductor nonvolatile memory which is specially arranged so as to execute or store program instructions, and the like, are included.

The effects of the light modulation method, the light modulation program, the light modulation device 2A, and the laser light irradiation device 1A according to the present embodiment will be described.

In the light modulation method, the light modulation program, and the light modulation device 2A shown in FIG. 1 to FIG. 3, with respect to a phase modulation pattern to be presented on the SLM 20, a target modulation pattern is set so as to correspond to a desired irradiation pattern or the like of laser light in the modulation pattern setting unit 31. Then, with respect to modulation of a phase of laser light with this target modulation pattern, in the correction coefficient setting unit 32, the two-dimensional pixel structure characteristics of the plurality of pixels in the SLM 20, and the pattern characteristics of the target modulation pattern are focused, and a correction coefficient α of 1 or more (α≧1), preferably a correction coefficient α which is greater than 1 (α>1) is set according to these pixel structure characteristics and pattern characteristics.

In accordance with such a configuration, in the modulation pattern correction unit 35, a corrected modulation pattern φ_{SLM} is created by multiplying the target modulation pattern φ_{CGH} by the correction coefficient α, and the corrected modulation pattern φ_{SLM} is presented on the plurality of pixels of the SLM 20, thereby it is possible to suppress the generation of undesired zeroth-order light in phase modulation of laser light in the SLM 20. Further, in accordance with this, it is possible to appropriately and accurately achieve a phase modulation operation of laser light in the SLM 20, and control of an irradiation pattern of the laser light for the object 50 thereby.

Further, in the laser light irradiation device 1A shown in FIG. 1, the irradiation device 1A is composed of the laser light source 10, and the light modulation device 2A having the above-described configuration including the phase-modulation type spatial light modulator 20. In accordance with such a configuration, in the light modulation device 2A, a modulation pattern corrected by multiplying the target modulation pattern by the correction coefficient α is presented on the SLM 20, thereby it is possible to suppress the generation of undesired zeroth-order light in the SLM 20, and it is possible to appropriately achieve operations such as irradiation of laser light onto the object 50 with a desired irradiation pattern, and processing and observation, etc., of the object 50 thereby. This laser light irradiation device 1A is suitably available as, for example, a laser processing device, a laser microscope, a laser manipulation device, or as an aberration correction device such as for a laser scanning ophthalmoscope, or the like.

Here, with respect to setting of a correction coefficient α in the correction coefficient setting unit 32, the configuration may be used in which the correction coefficient storage unit 33 which stores the correction coefficient α which is determined in advance according to the pattern characteristics so as to correspond to the target modulation pattern is provided, and the correction coefficient α is set in the setting unit 32 according to a coefficient read out from the storage unit 33. In this way, pattern characteristics of a modulation pattern to be presented on the SLM 20 are evaluated in advance, a coefficient α is determined according to the pattern characteristics, to be stored as coefficient data in the storage unit 33, and the coefficient data is read out as needed, to be set as a correction coefficient α, thereby it is possible to appropriately set the correction coefficient α corresponding to the target modulation pattern.

Or, with respect to setting of a correction coefficient α, the configuration may be used in which the correction coefficient derivation unit 34 which determines the correction coefficient α by a predetermined calculation or the like according to the pattern characteristics with reference to the target modulation pattern is provided, and the correction coefficient α is set in the setting unit 32 according to a coefficient determined by the derivation unit 34. In this way, pattern characteristics are evaluated by a calculation or the like with reference to a target modulation pattern which is set as a modulation pattern to be presented on the SLM 20, and a coefficient is determined according to the pattern characteristics, to set a correction coefficient α, thereby it is also possible to appropriately set the correction coefficient α corresponding to the target modulation pattern.

Further, the configuration may be used in which the correction coefficient α is set as a coefficient α(x, y) for each pixel dependent on a two-dimensional pixel position (x, y) of each of the plurality of pixels in the SLM 20. In the phase modulation pattern to be presented on the SLM 20, a case where a value of the correction coefficient α by which the modulation pattern is to be multiplied varies depending on a pixel position (x, y) in accordance with its specific pattern configuration may be considered. In contrast, with the configuration in which it is possible to set the correction coefficient α as a coefficient α(x, y) for each pixel as described above, thereby it is possible to appropriately execute correction of the modulation pattern. In this case, the corrected modulation pattern φ_{SLM} is determined as follows.

φ_{SLM}(x,y)=φ_{CGH}(x,y)×α(x,y)

Here, in the case where the dependence of a correction coefficient α on a pixel position is low or the like, a correction coefficient α may be a constant value independent of a pixel position.

Further, with respect to the pattern characteristics of the modulation pattern to be referenced in setting of a correction coefficient α, specifically, the configuration may be used in which a coefficient set according to spatial frequency characteristics of the target modulation pattern is used as the correction coefficient α. Or, the configuration may be used in which a coefficient set according to a point having a maximum diffraction angle in a reconstructed pattern of laser light phase-modulated with the target modulation pattern is used as the correction coefficient α. In this case, in particular, a coefficient set according to a distance between the point having the maximum diffraction angle in the reconstructed pattern of the laser light phase-modulated with the target modulation pattern and a light condensing point of zeroth-order light is preferably used as a correction coefficient α. In addition, a method of setting a correction coefficient α, or the like will be further described later in detail.

The phase modulation of laser light, the design and correction of a modulation pattern, and the like in the laser light irradiation device 1A and the light modulation device 2A shown in FIG. 1 to FIG. 3 will be described in more detail.

First, generation of undesired zeroth-order light in phase modulation of laser light using the SLM 20 having the plurality of two-dimensionally arrayed pixels will be described. Undesired zeroth-order light is, as described above, generated by a light component which is not modulated in the SLM 20 due to the two-dimensional pixel structure or the like of the SLM 20. Such a light component is condensed as unexpected light on a focal position in the case, for example, where a lens is disposed at the subsequent stage of the SLM. In addition, in reality, because a wave front of output light is distorted by a distortion or the like in the SLM 20, a light condensing position of the undesired zeroth-order light may be slightly shifted from the above-described focal position in some cases.

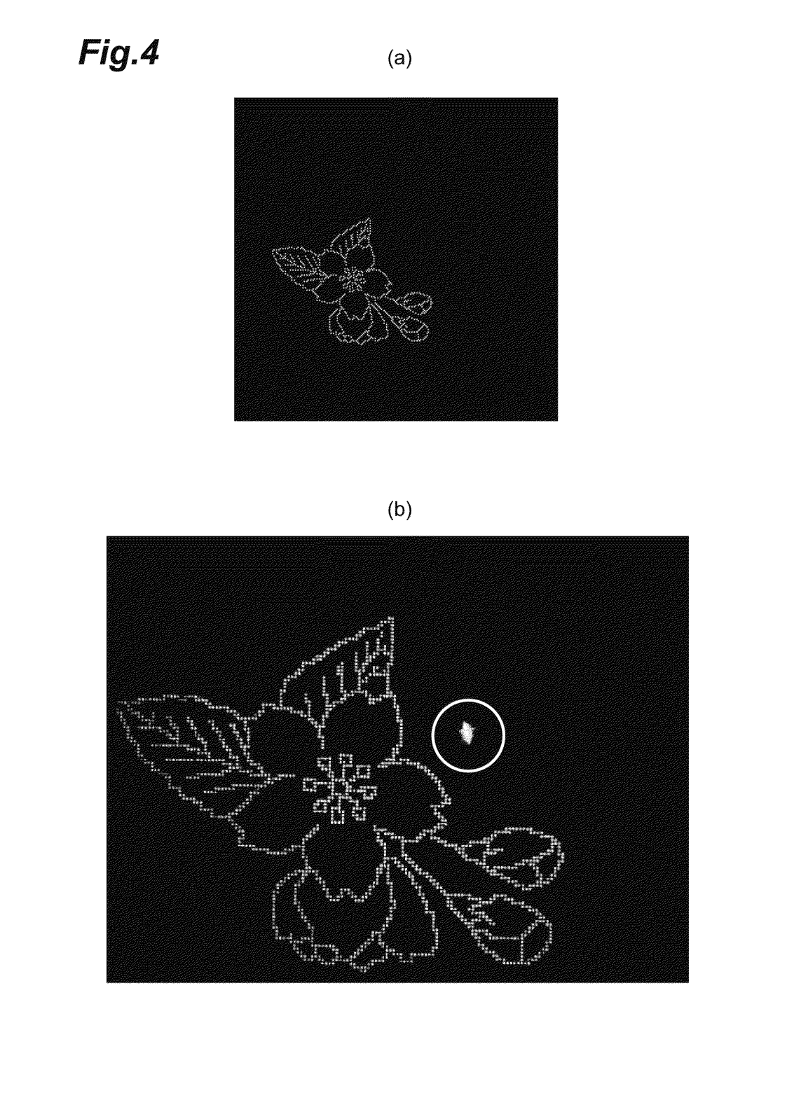

The reason for that undesired zeroth-order light is called “unexpected light” is because this zeroth-order light is not generated at a stage of design or simulation of a CGH carried out under ideal conditions. Here, FIG. 4 includes diagrams showing the generation of undesired zeroth-order light in a reconstructed pattern of phase-modulated laser light by the spatial light modulator (SLM). For example, a CGH as a target modulation pattern is designed so as to reconstruct a multispot laser light irradiation pattern as shown in (a) in FIG. 4 on a reconstruction plane perpendicular to an optical axis at a focal position of the lens.

A reconstructed pattern of laser light is determined by simulation by use of a target modulation pattern designed as described above, thereby reconstructing a multispot pattern which is the same as that in (a) in FIG. 4. On the other hand, when reconstruction of a laser light irradiation pattern is performed by actually presenting a target modulation pattern to the plurality of pixels of the SLM, as shown by encircling it in (b) in FIG. 4, a condensed light spot of undesired zeroth-order light which is unexpected light is generated.

The existence of such undesired zeroth-order light becomes a problem, particularly, in the case where a multispot laser light irradiation pattern is created to perform processing, and the like of an object. For example, in the case where a desired one-point laser light irradiation pattern and an undesired zeroth-order light spot pattern are reconstructed by the SLM 20, provided that the light component of 99% in the laser light is diffracted, and the light component of 1% becomes undesired zeroth-order light, an S/N ratio is to be 99. In such a case, provided that the energy of the undesired zeroth-order light is made to be less than or equal to a processing threshold value for an object by adjusting, etc., a light amount of the laser light input to the SLM, by utilizing that high S/N ratio, it is possible to avoid the influence of the undesired zeroth-order light.

Next, in consideration of the case where a desired 99-point laser light irradiation pattern and an undesired zeroth-order light pattern are reconstructed by the SLM 20, provided that the light component of 1% is diffracted to each point in the 99-point irradiation pattern, and the light component of 1% becomes undesired zeroth-order light, an S/N ratio per point is 1. In such a case, it is impossible to avoid the influence of the undesired zeroth-order light by merely adjusting a light amount of the laser light input to the SLM, and for example, an operation that, such as, the undesired zeroth-order light is masked to be blocked by any method, or a Fresnel lens pattern is added to a CGH presented on the SLM, thereby shifting reconstruction positions of the undesired zeroth-order light and the CGH in the optical axis direction, which defocuses the zeroth-order light on the reconstruction plane of the CGH, is required.

Further, in the above description, the multispot processing by the laser light is shown, however, generation of undesired zeroth-order light by the SLM becomes a problem, in addition to multispot processing, for the purpose of application using multispot such as a multispot laser scanning microscope, or further, in aberration correction of a single point such as a laser scanning ophthalmoscope, light condensing point position movement, and the like, and moreover, presents a problem on the overall purpose of performing phase modulation of laser light by the SLM such as correlation and LG beam reconstruction.

Such undesired zeroth-order light by the SLM is generated because the modulation pattern to be actually presented on the SLM is changed from the target modulation pattern designed under the ideal conditions due to the pixel structure characteristics held by the plurality of pixels of the SLM, and the phase modulation characteristics. Such a change in the modulation pattern in the SLM may be, for example, due to the influence of a pixel gap in the pixel structure of the SLM shown in FIG. 2, that is, a space between pixels adjacent to each other.

As the influence of a pixel gap in phase modulation in the SLM, in detail, for example, it may be considered that, because the liquid crystal in the pixel gap does not receive a voltage by the pixel electrode, phase modulation is not performed onto the light input to the pixel gap (Non-Patent Document 5). In this case, it has been considered that light components which have not been phase modulated in the pixel gap are condensed to become undesired zeroth-order light.

Meanwhile, it has been found out that, in reality, the influence by crosstalk between the pixels of the SLM by expansion of an electric field due to a pixel gap is great. This is because, a uniform voltage is applied to the electrode on the glass substrate side with respect to the structure which is partitioned in pixel units on the silicon substrate side, and therefore, crosstalk between the pixels of the SLM is caused by expansion of an electric field in the electrode on the glass substrate side. That is, in the liquid crystal in the pixel gap, although phase modulation is performed onto input laser light, the behavior becomes unstable under the influence of the adjacent pixels, and, as a result, the phase of the laser light input to the pixel gap becomes an unexpected value. In particular, in the case where a potential difference between a pixel and an adjacent pixel is large, a strong potential difference is generated laterally, and not only the pixel gap, but also the behavior of the liquid crystal inside the pixels may become unstable.

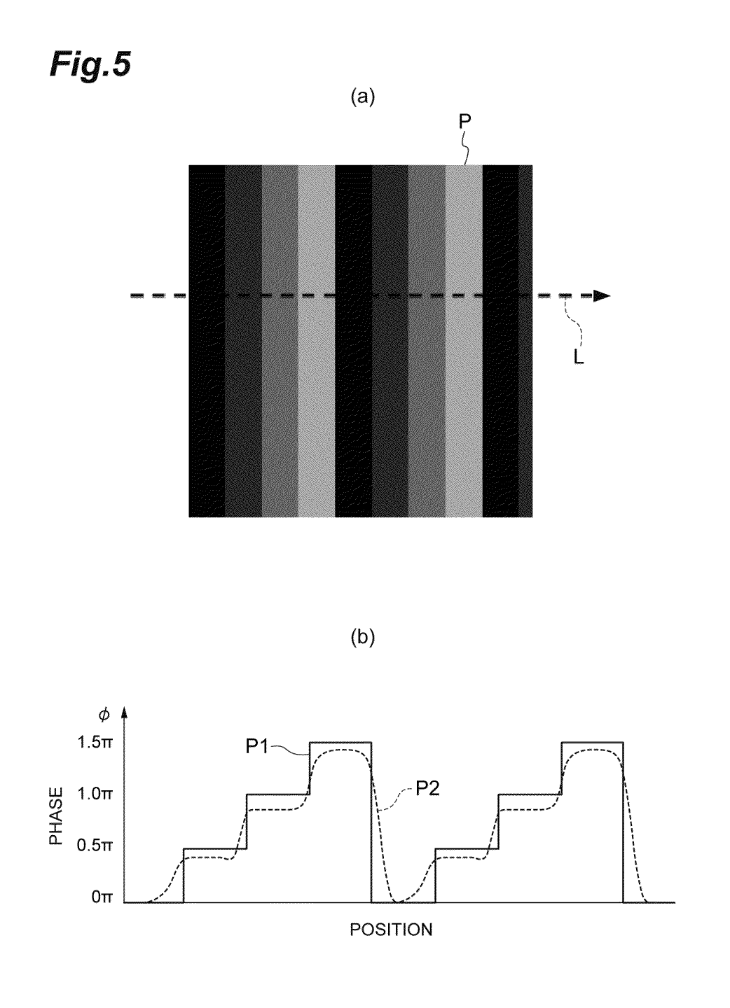

FIG. 5 includes diagrams showing the influence of a pixel gap in phase modulation of laser light by the SLM. Here, as shown on the two-dimensional pattern P in (a) in FIG. 5 and on the solid line graph P1 in (b) in FIG. 5, a blazed diffraction grating with four values composed of phase values 0π, 0.5π, 1π, and 1.5π (rad) will be considered. In addition, in (a) in FIG. 5, the phases 0 to 2π (rad) are expressed by 0 to 255 gradations, thereby expressing the two-dimensional phase modulation pattern P in the blazed diffraction grating. Further, the graph P of (b) in FIG. 5 shows the profile on the dashed line L in the phase pattern P of (a) in FIG. 5.

In the case where a phase pattern of such a blazed diffraction grating is presented on the SLM under the ideal conditions, undesired zeroth-order light is not generated in phase-modulated light output from the SLM. In contrast, when a phase modulation pattern is actually presented on the SLM, the presented pattern does not become an ideal stepwise phase pattern by crosstalk between the pixels due to the influence of the pixel structure including a pixel gap in the SLM, but a blunt shaped pattern as shown on the dashed line graph P2 of (b) in FIG. 5. In this case, due to the influence of the blunt modulation pattern, undesired zeroth-order light is generated in phase-modulated light output from the SLM.

In the laser light irradiation device 1A and the light modulation device 2A shown in FIG. 1 to FIG. 3, for the influences by a pixel gap in the pixel structure of the SLM 20, and crosstalk between the pixels, the corrected modulation pattern φ_{SLM} to be actually presented on the plurality of pixels of the SLM 20 is created by setting a correction coefficient α of one or more and multiplying the target modulation pattern φ_{CGH} by the correction coefficient α. In accordance with the results of the study by the inventors of the present application, it is possible to suppress the generation of undesired zeroth-order light in phase-modulated light by a simple method by correcting a phase modulation pattern with a coefficient α of α≧1 in this way. For example, in the case where the intensity of zeroth-order light is reduced to 1/10, it is possible to reconstruct irradiation points in number ten times of that of the conventional art in multispot irradiation of laser light by improvement in an S/N ratio.

In addition, with respect to the phase modulation pattern to be presented on the SLM 20, the phase pattern for expressing the blazed diffraction grating is exemplified in FIG. 5, however, it is possible to apply the above-described correction method using the coefficient α to, not only such a phase pattern, but also a variety of phase modulation patterns specifically. Such phase modulation patterns include, for example, a phase pattern for expressing a desired one-point, multispot, linear, or planer pattern or the like, a correction pattern for correcting a distortion in an SLM, a correction pattern for correcting aberration in an optical system or the like, a Fresnel lens pattern for moving a focal position or the like, a pattern for generating light having particular properties such as optical vortex and non-diffracting beam or the like, or a phase pattern of a combination of the plurality of those patterns, and the like.

The suppression effect on undesired zeroth-order light from the SLM by the above-described correction formula of a modulation pattern using a correction coefficient α

φ_{SLM}(x,y)=φ_{CGH}(x,y)×α

was verified by use of a blazed diffraction grating phase modulation pattern.

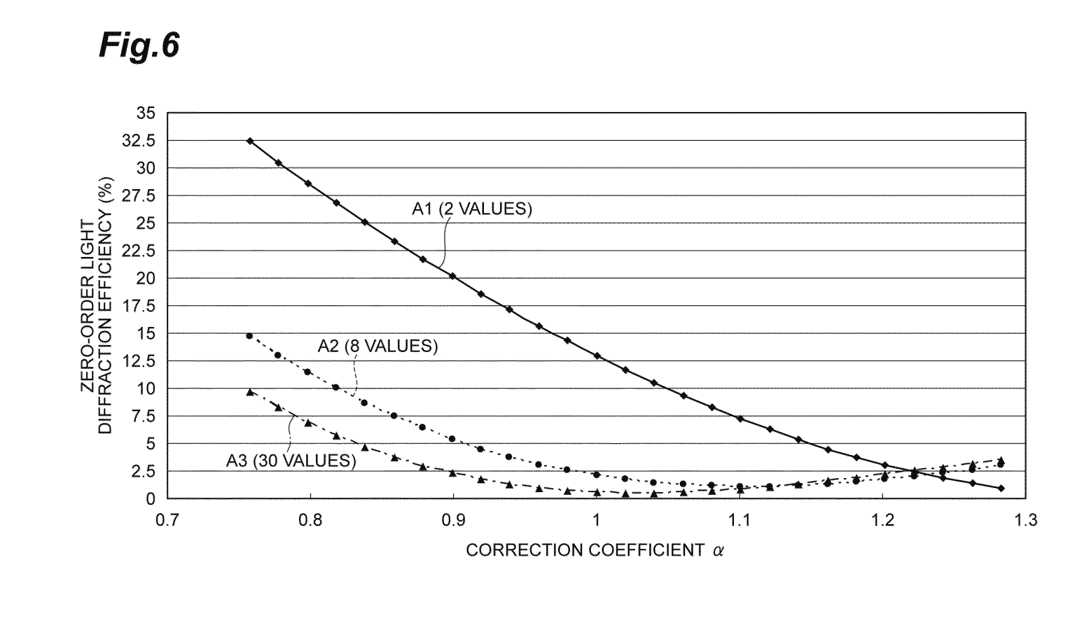

FIG. 6 is a graph showing changes in diffraction efficiency of zeroth-order light according to a correction coefficient α in phase-modulated laser light output from the SLM. In the graph of FIG. 6, the horizontal axis shows the correction coefficients α by which the modulation pattern is multiplied, and the vertical axis shows the diffraction efficiencies (%) of the zeroth-order light corresponding to the intensities of undesired zeroth-order light. Further, in FIG. 6, the graphs A1, A2, and A3 respectively show the results of measuring the intensities of the zeroth-order light while changing the value of the coefficient α by use of phase modulation patterns of blazed diffraction gratings with a two-value and two-pixel cycle, an eight-value and eight-pixel cycle, and a thirty-value and thirty-pixel cycle. In addition, with respect to the diffraction efficiencies of the zeroth-order light, an uniform phase modulation pattern was presented on the SLM in advance, an intensity of the light when light was condensed by the lens at the subsequent stage so as to cause the SLM to function as a mirror is recorded, and this intensity was set as a denominator, and the intensity of the zeroth-order light measured when the blazed diffraction grating pattern was presented is set as a numerator, to determine its diffraction efficiency.

In the verification results shown in FIG. 6, in the case where a correction coefficient is α=1, the diffraction efficiencies of the zeroth-order light are respectively 13%, 2%, and 0.5% on the graphs A1, A2, and A3. Further, from the respective graphs in FIG. 6, it is understood that the diffraction intensity of the zeroth-order light varies when the correction coefficient α is varied, and the intensity of the zeroth-order light under each condition when α<1 is higher than that when α=1. Further, the values of the correction coefficient α by which the diffraction efficiency of the zeroth-order light is minimized are respectively α=1.28, 1.10, and 1.02 on the graphs A1, A2, and A3, which were different values according to a modulation pattern serving as a correction object. Further, the diffraction efficiencies of the zeroth-order light at this time are respectively 1.0%, 1.0%, and 0.4%, that is generation of undesired zeroth-order light is suppressed in each case as compared with the case where the correction coefficient is α=1.

In addition, here, the verification was carried out with the patterns having only one spatial frequency component, however, an actual pattern such as a CGH has a plurality of spatial frequency components, and is influenced by a main spatial frequency component. A main spatial frequency component is composed of the outermost reconstructed point in many cases, meanwhile, for example, in the case where the energy of the outermost point is low, the influence by that point is small, and a point with a large diffraction angle and high energy after that outermost point have an influence as a main component.

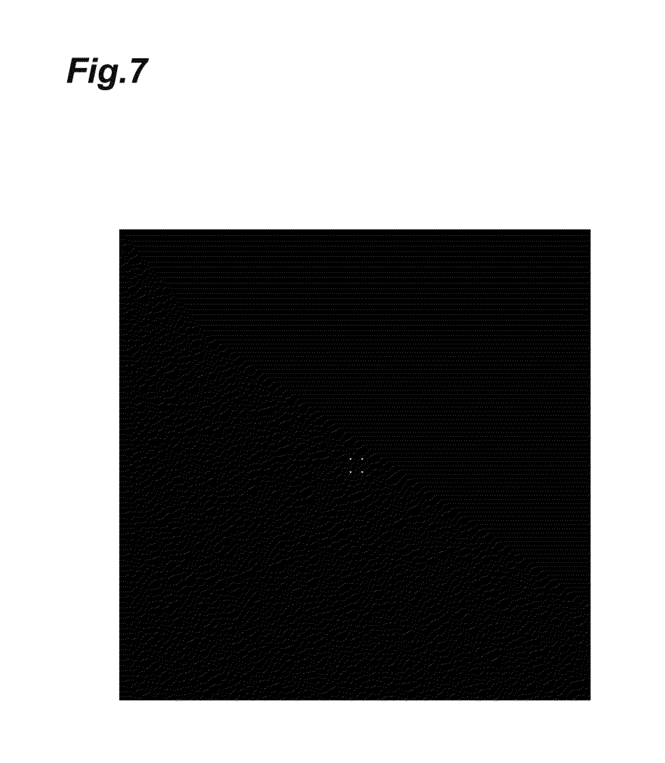

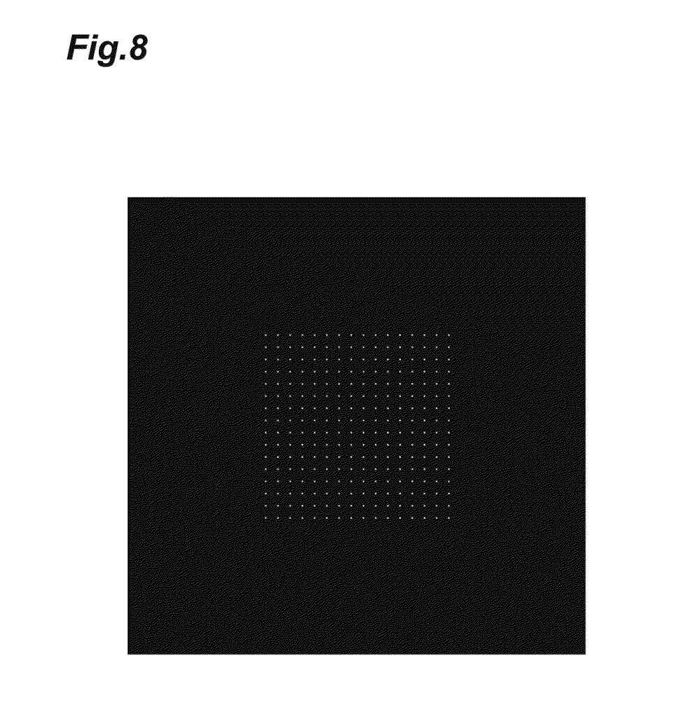

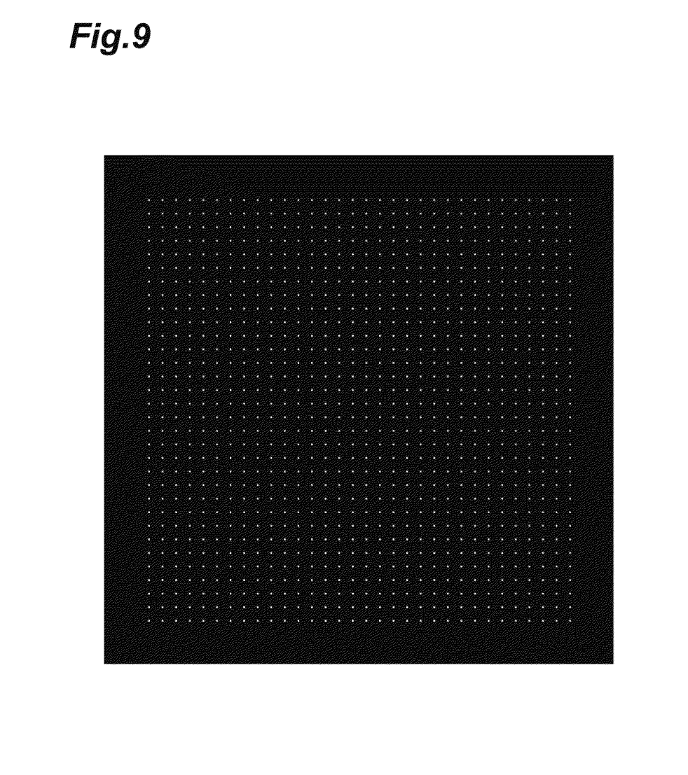

Next, the effects of the correction coefficient α in the case where a complicated pattern other than a blazed diffraction grating is used were verified. In detail, phase modulation patterns corresponding to rectangular multispot reconstructed patterns with 2×2 points, 16×16 points, and 32×32 points at equal point intervals, which are respectively shown in FIGS. 7, 8, and 9 were determined, to verify those.

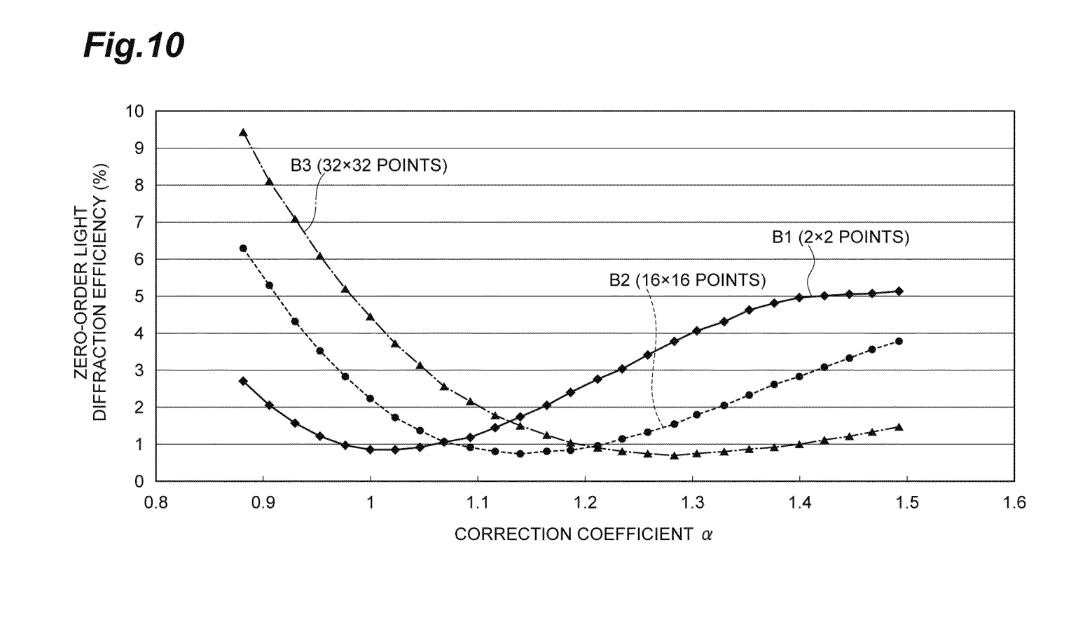

FIG. 10 is a graph showing changes in diffraction efficiency of zeroth-order light according to a correction coefficient α for the multispot reconstructed patterns shown in FIGS. 7, 8, and 9. In FIG. 10, the graphs B1, B2, and B3 respectively show the results of measuring the intensities of the zeroth-order light while changing a coefficient α by use of the phase modulation patterns corresponding to the multispot reconstructed patterns with 2×2 points, 16×16 points, and 32×32 points.

In the verification results shown in FIG. 10, in the case where a correction coefficient is α=1, the diffraction efficiencies of the zeroth-order light are respectively 0.8%, 2.2%, and 4.4% on the graphs B1, B2, and B3. Further, from the respective graphs in FIG. 10, it is understood that the diffraction intensity of the zeroth-order light varies when the correction coefficient α is varied, and the intensity of the zeroth-order light under each condition when α<1 is higher than that when α=1.

Further, the values of the correction coefficient α by which the diffraction efficiency of the zeroth-order light is minimized are respectively α=1, 1.10, and 1.28 on the graphs B1, B2, and B3, which were different values according to a modulation pattern. Further, the diffraction efficiencies of the zeroth-order light at this time are respectively 0.8%, 0.7%, and 0.7%, that is generation of undesired zeroth-order light is suppressed in each case as compared with the case where the correction coefficient is α=1. In this way, it is possible to easily suppress the generation of zeroth-order light by multiplying the phase modulation pattern presented on the SLM by a correction coefficient α set according to its pattern characteristics.

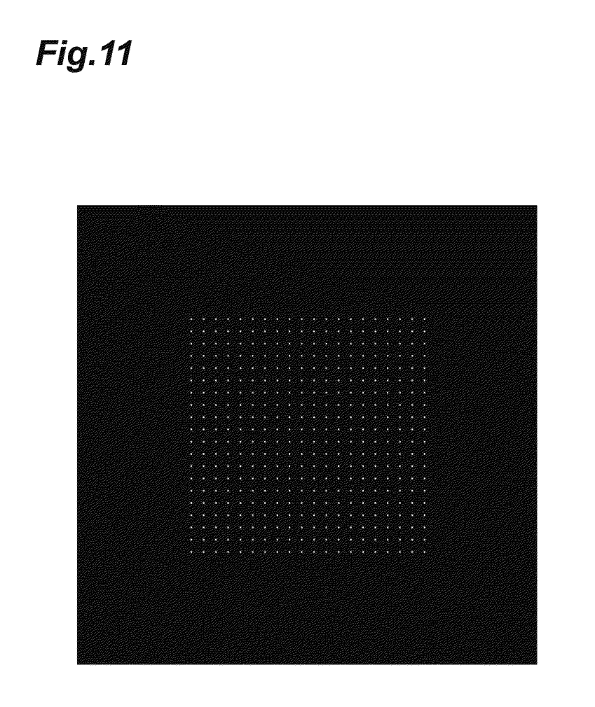

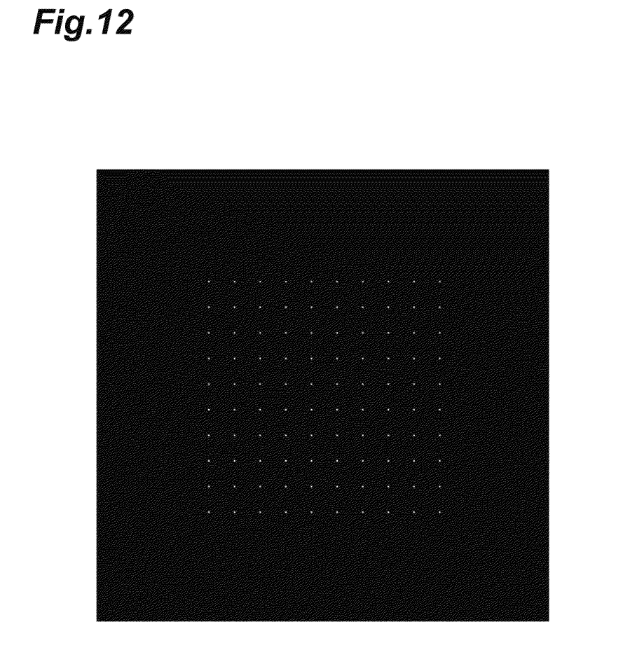

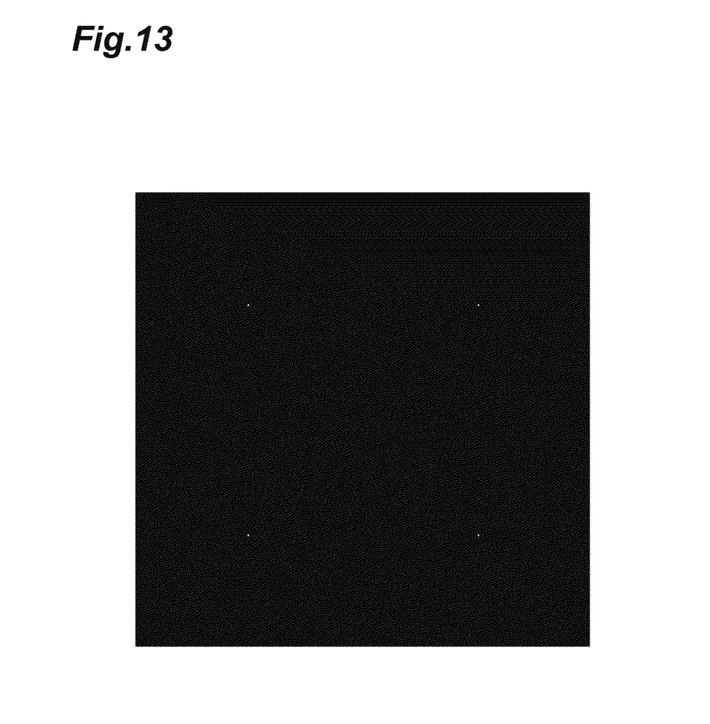

Next, verification of the effect of a correction coefficient α was carried out with respect to the multispot reconstructed patterns of which the positions of the outermost reconstructed point are equal. In detail, phase modulation patterns corresponding to rectangular multispot reconstructed patterns with 20×20 points, 10×10 points, and 2×2 points of which the positions of the outermost reconstructed points (corresponding to a point having a maximum diffraction angle in a reconstructed pattern) are equal, and which are respectively shown in FIGS. 11, 12, and 13 were determined, to verify those.

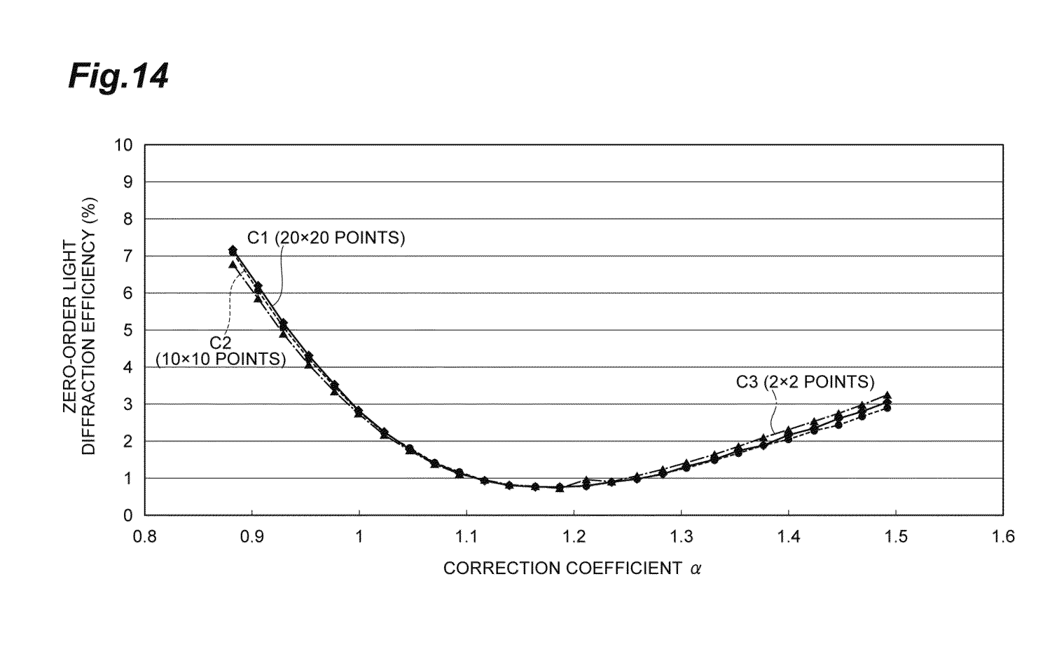

FIG. 14 is a graph showing changes in diffraction efficiency of zeroth-order light according to a correction coefficient α for the multispot reconstructed patterns shown in FIGS. 11, 12, and 13. In FIG. 14, the graphs C1, C2, and C3 respectively show the results of measuring the intensities of the zeroth-order light while changing a coefficient α by use of the phase modulation patterns corresponding to the multispot reconstructed patterns with 20×20 points, 10×10 points, and 2×2 points of which the positions of the outermost reconstructed points are equal.

In the verification results shown in FIG. 14, it is understood from the respective graphs that the diffraction intensity of the zeroth-order light varies when the correction coefficient α is varied, and it is understood that the intensity of the zeroth-order light under each condition when α<1 is higher than that when α=1. Further, the value of the correction coefficient α by which the diffraction efficiency of the zeroth-order light is minimized is approximate to α=1.18 in each graph. Although the numbers of reconstructed points are different on these graphs C1, C2, and C3 as described above, when a position of the outermost reconstructed point in a reconstructed pattern is known, it is possible to analogize an optimum correction coefficient α from the position.

The setting and derivation of the correction coefficient α with respect to the target modulation pattern will be described. As shown in the respective specific examples described above, the optimum correction coefficient α is different for each CGH serving as a modulation pattern, and a coefficient α by which the intensity of zeroth-order light is minimized exists for each CGH. It is possible to determine an optimum correction coefficient α for a modulation pattern on the basis of a measurement result by use of an evaluation optical system or a calculation result by simulation or the like.

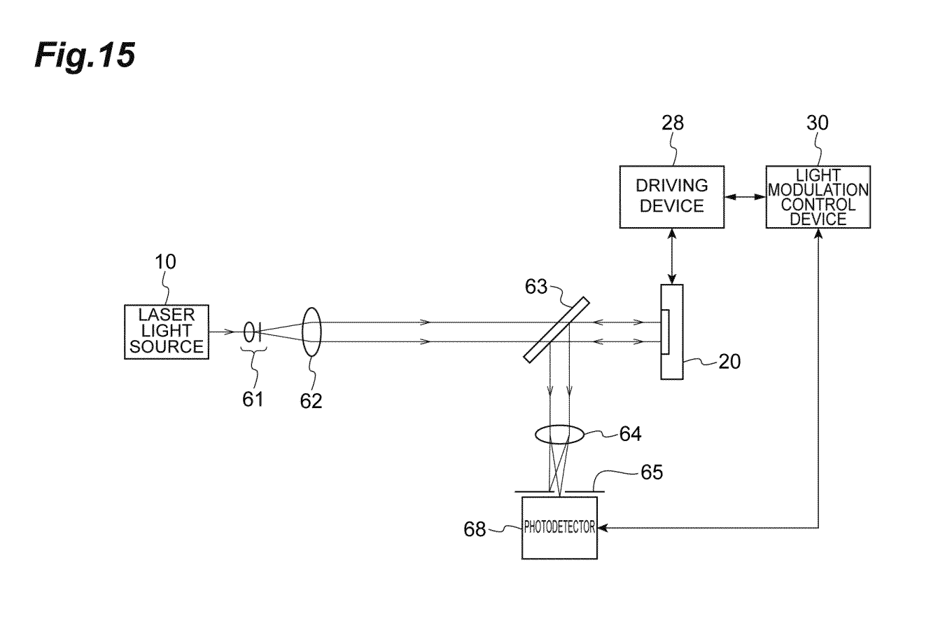

FIG. 15 is a diagram showing an example of an evaluation optical system used for derivation of a correction coefficient α for a phase modulation pattern. In the configuration shown in FIG. 15, laser light from the laser light source 10 is expanded by a spatial filter 61 and a collimator lens 62, and thereafter transmits through a half mirror 63. The laser light from the half mirror 63 is phase-modulated by a reflective type spatial light modulator (SLM) 20.

Then, the phase-modulated reflected laser light output from the SLM 20 is reflected by the half mirror 63, to be imaged as its light condensing reconstructed image by a photodetector 68 via a lens 64 and an aperture 65. With this reconstructed image of the laser light, it is possible to evaluate light condensing control of the laser light by phase modulation in the SLM 20, and a generation status of undesired zeroth-order light, and derive a correction coefficient α by conditions, for example, under which the intensity of zeroth-order light is minimized, and the like.

In addition, as the photodetector 68 that detects a light condensing reconstructed image, for example, a camera, a photodiode (PD), or the like may be used. Further, with respect to the configuration of an optical system including a spatial filter, a lens, a mirror, and the like, various configurations other than the example shown in FIG. 15 are available. Further, such an evaluation optical system may be provided separately from the laser light irradiation device 1A and the light modulation device 2A shown in FIG. 1. Or, an evaluation optical system may be incorporated as a part of the laser light irradiation device 1A or the light modulation device 2A. In the case where an evaluation optical system is incorporated in this way, there is the advantage that it is possible to execute processing, observation, and the like of an object immediately after evaluation of zeroth-order light, and setting of a correction coefficient α thereby.

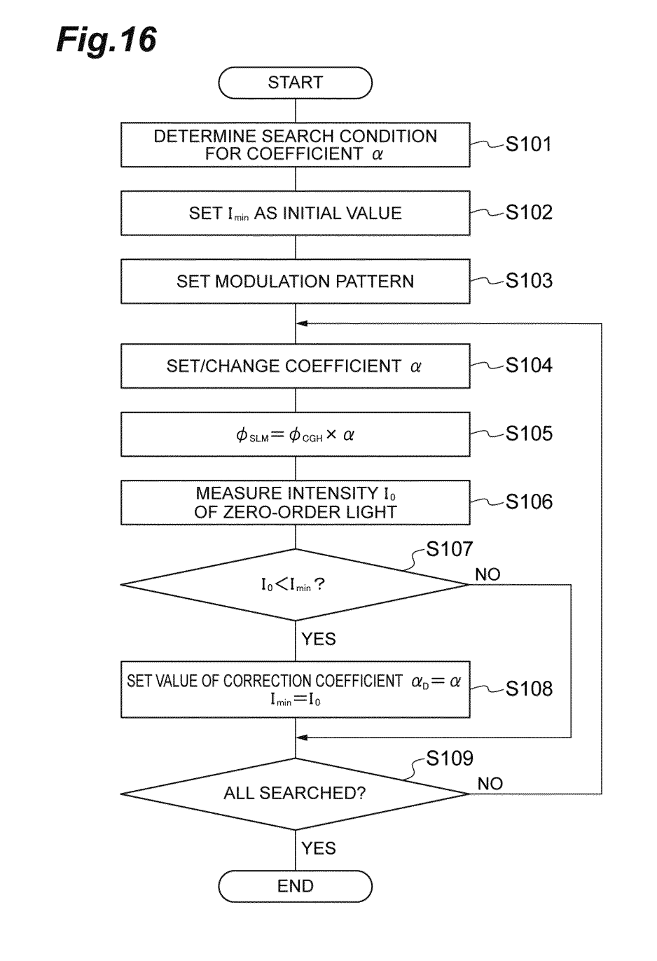

FIG. 16 is a flowchart showing an example of a method of setting a correction coefficient α which is carried out by use of the evaluation optical system shown in FIG. 15, or the like. In this method, first, search conditions for a correction coefficient α, that is, specifically, a search range and a search interval for a coefficient α are determined (Step S101). Further, an intensity value Iₘᵢₙ for searching a minimum value of an intensity of zeroth-order light is set to a relatively large initial value (for example, Iₘᵢₙ=100) (S102). Then, a modulation pattern φ_{CGH} serving as an object to be searched for a correction coefficient α is set (S103). Here, a CGH is newly prepared, or a necessary CGH is read out of the data stored in the storage unit, to set an object modulation pattern.

After an object modulation pattern is set, a value of a correction coefficient α for first evaluation for the pattern is set (S104), and a corrected modulation pattern φ_{SLM}

φ_{SLM}(x,y)=φ_{CGH}(x,y)×α

is determined by multiplying the modulation pattern φ_{CGH} by the correction coefficient α (S105). Then, this corrected modulation pattern φ_{SLM} is presented on the SLM, to measure the intensity I₀ of zeroth-order light at that time (S106).

Moreover, the measured intensity value I₀ is compared with the intensity minimum value Iₘᵢₙ of the zeroth-order light at that point of time (S107). As a result of the comparison, in the case of I₀<Iₘᵢₙ, with the evaluated coefficient value α being set to a set value α_{D}=α_{Desire} of the correction coefficient α (α_{D}=α), and Iₘᵢₙ=I₀, the intensity minimum value Iₘᵢₙ of the zeroth-order light is replaced (S108). When it is I₀≧Iₘᵢₙ, the coefficient α_{D} and the searched value Iₘᵢₙ of the intensity minimum value are left as they are.

Then, with respect to the correction coefficient α for the modulation pattern, it is confirmed whether or not the evaluations with all the search values are completed (S109), and when it is not completed, a value of the correction coefficient α to be evaluated is changed (S104), and the measurement and evaluation shown in Steps S104 to S108 are repeatedly executed. When the evaluations for the correction coefficient α with all the search values are completed, a correction coefficient α for a modulation pattern serving as an object is determined, then the search is completed. Such derivation processing of a correction coefficient α can be manually executed by an operator, or automatically executed by use of a predetermined derivation program.

In addition, with respect to evaluation of undesired zeroth-order light and setting of a correction coefficient α for a phase modulation pattern to be presented on the SLM, as described above for FIG. 3, the configuration may be used in which the correction coefficients α are determined in advance to be stored in the storage unit 33, and when a target modulation pattern is set, a correction coefficient α corresponding to the pattern is read out of the storage unit 33. Or, the configuration may be used in which evaluation of zeroth-order light and derivation of a correction coefficient α are carried out in the derivation unit 34 in accordance with a target modulation pattern when the target modulation pattern is set.

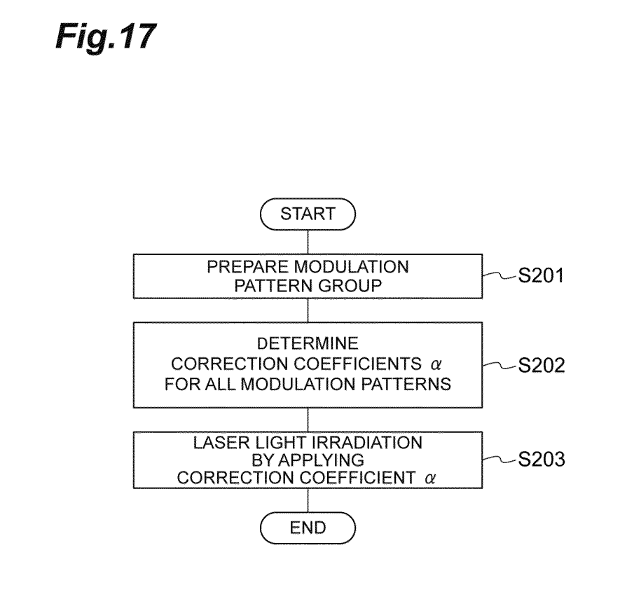

Further, in the case where there are a plurality of modulation patterns serving as setting objects for a correction coefficient α, as shown in a flowchart of FIG. 17, for example, the configuration may be used in which the correction coefficients α are determined in advance for all the modulation patterns. In the method of FIG. 17, first, a modulation pattern group including a plurality of modulation patterns is prepared (S201), and processing of determining correction coefficients α is carried out for all the modulation patterns (S202). Then, laser light irradiation is performed by applying the determined correction coefficient α by use of the respective modulation patterns in the modulation pattern group (S203).

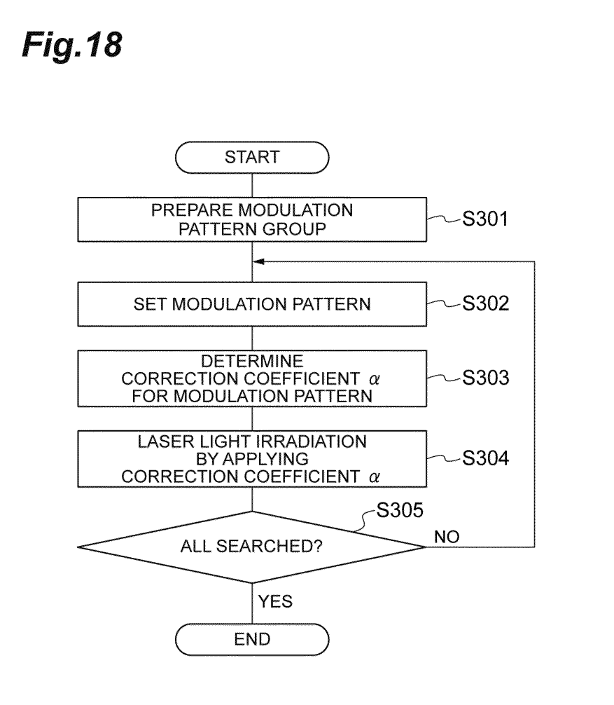

Or, in the case where there are a plurality of modulation patterns, as shown in a flowchart of FIG. 18, the configuration may be used in which a correction coefficient α is individually determined for each modulation pattern. In the method of FIG. 18, first, a modulation pattern group including a plurality of modulation patterns is prepared (S301), and in the group, a modulation pattern serving as an object for determining a correction coefficient α, and to be applied to laser light irradiation is set (S302). After a modulation pattern serving as an object is set, processing of determining a correction coefficient α for the modulation pattern is carried out (S303), and laser light irradiation is performed by applying the determined correction coefficient α (S304). Moreover, it is confirmed whether or not search for a correction coefficient α, laser light irradiation, and the like for all the modulation patterns are completed (S305), and when it is not completed, the setting of a modulation pattern, the determination of a correction coefficient α, and the laser light irradiation shown in Steps S302 to S304 are repeatedly executed. When search for a correction coefficient α and the like for all the modulation patterns are completed, determination of a correction coefficient α, laser light irradiation using the correction coefficient α, and the like are completed.

In addition, with respect to evaluation of undesired zeroth-order light generated in the SLM, and setting of a correction coefficient α, the configuration in which a light condensing reconstructed image of phase-modulated laser light is detected by the photodetector 68 is exemplified in the evaluation optical system of FIG. 15, however, those are not limited to such a configuration, and for example, setting of a correction coefficient α may be carried out with reference to a processing result of an object by a laser processing device, or an observation result of an object by a laser microscope, and the like. For example, in the case where a processing result by a laser processing device is used, because undesired processing by zeroth-order light is carried out onto a processing object, it is possible to determine a correction coefficient α by evaluating a hole diameter, a hole depth, or the like in that processing result.

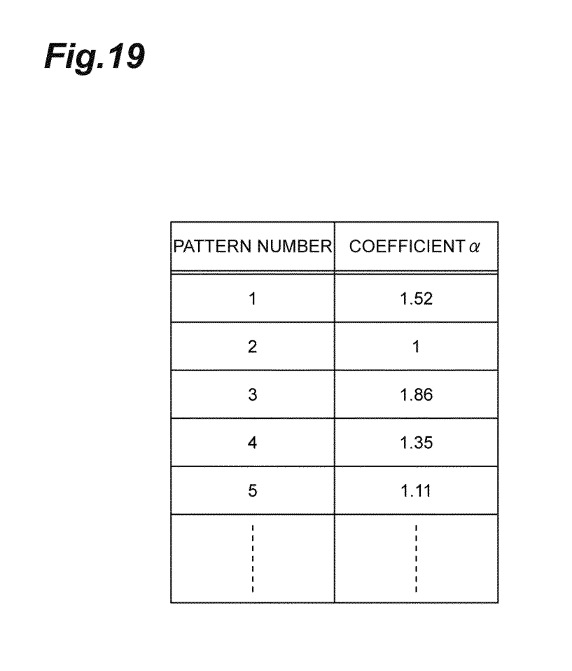

Further, in the case where setting of a correction coefficient α is carried out for each of the plurality of phase modulation patterns used in the light modulation device 2A, as shown in FIG. 19, the configuration may be used in which a look up table (LUT) showing the correspondence relationship between target modulation patterns and correction coefficients α is prepared. In an LUT of FIG. 19, the pattern numbers 1, 2, 3, 4, 5, . . . for specifying a modulation pattern, and the values of correction coefficients α 1.52, 1, 1.86, 1.35, 1.11, . . . corresponding to the pattern numbers are stored so as to correspond to each other.

Further, for example, in the case where a coefficient set according to a point having a maximum diffraction angle in a reconstructed pattern is used, an optical system as in FIG. 15 and for example a blazed diffraction grating are used, to measure coefficients α at several reconstructed point positions. Thereafter, a correction coefficient α may be applied to a target modulation pattern with reference to a measurement result from the reconstructed patterns by use of an approximation method or an interpolating method or the like.

Such an LUT is stored, for example, in the correction coefficient storage unit 33 in the configuration shown in FIG. 3. Further, in the case where an LUT is used, the correction coefficient setting unit 32 sets the correction coefficient α for the target modulation pattern set by the modulation pattern setting unit 31 by reading out a correction coefficient α corresponding to the pattern from the LUT in the storage unit 33. In addition, such an LUT is provided separately from an LUT for converting a signal of a phase value into a voltage instruction value.

Here, with respect to pattern characteristics of a phase modulation pattern to be referenced at the time of setting a correction coefficient α, in the case where evaluation of undesired zeroth-order light and determination of a correction coefficient α are carried out by use of an evaluation optical system as described above, the pattern characteristics are taken into account through the evaluation and determination processing, to set a correction coefficient α corresponding to the pattern characteristics.

Further, as a correction coefficient α corresponding to the pattern characteristics, as described above, a coefficient set according to spatial frequency characteristics of the target modulation pattern may be used. For example, as shown in the graph of FIG. 6 for the diffraction grating patterns, a value of an optimum correction coefficient α varies according to a spatial frequency component of a modulation pattern serving as an object. Accordingly, a correction coefficient α may be determined from a trend of frequency components in a target modulation pattern by utilizing such a phenomenon. In this case, in the case where a frequency component differs at each position in the modulation pattern, a correction coefficient α may be set as a coefficient α(x, y) which differs at each pixel position. Further, in the case where an LUT is prepared for such correction coefficients α, the modulation patterns and the correction coefficients α may be directly made to correspond to each other, or the trends of the frequency components in the modulation patterns and the correction coefficients α may be made to correspond to each other.

Further, as a correction coefficient α, a coefficient set according to a point having a maximum diffraction angle in a reconstructed pattern of laser light phase-modulated with the target modulation pattern may be used. Further, in this case, for example, as a correction coefficient α, a coefficient set according to a distance between the point having the maximum diffraction angle in the reconstructed pattern of the laser light phase-modulated with the target modulation pattern and a light condensing point of zeroth-order light is preferably used.

For example, as shown in the graph of FIG. 14 about the position of the outermost reconstructed point in a reconstructed pattern of laser light, a value of an optimum correction coefficient α varies according to a point having the maximum diffraction angle in the reconstructed pattern (corresponding to the outermost reconstructed point). Accordingly, a correction coefficient α for a modulation pattern may be determined by utilizing such a phenomenon. Further, in the case where an LUT is prepared for such a correction coefficient α, modulation patterns and correction coefficients α may be directly made to correspond to each other, or the positions of points having the maximum diffraction angles in the reconstructed patterns and correction coefficients α may be made to correspond to each other.

Further, as described above, in addition to the configuration in which zeroth-order light is reduced by applying a correction coefficient α to a modulation pattern, a lens effect with a Fresnel lens pattern, a Fresnel zone plate, or the like may be given to a CGH as a modulation pattern, thereby defocusing the reconstruction position of the CGH and the zeroth-order light. Here, in the case where the intensity of undesired zeroth-order light is high, in order to prevent the influence of interference with a desired irradiation pattern of laser light, it is necessary to defocus the zeroth-order light at the CGH reconstruction position in a large way by enlarging a focal length of the Fresnel lens.

In such a case, because a phase of the Fresnel lens is increased by the square of a distance from the central portion, its phase gradient becomes steeper at the peripheral portion. Therefore, the influence may be exercised on the phase expression ability of the SLM, such as a lowering in the diffraction efficiency at the peripheral portion. In contrast, in the configuration in which a correction coefficient α is applied as described above, because the intensity of zeroth-order light is suppressed to be low, a focal length of the Fresnel lens becomes short, and its phase gradient becomes gradual. In accordance with this, it is expected to reduce the burden of the SLM.

Or, in addition to the configuration in which zeroth-order light is reduced by applying a correction coefficient α, a shielding plate or the like may be further disposed at a predetermined position of the optical system, thereby blocking zeroth-order light. In this case, because the intensity of the zeroth-order light is suppressed to be low by the correction coefficient α, an effect such as prevention of processing onto the shielding plate by the zeroth-order light is expected.

Further, a target modulation pattern φ_{CGH}(x, y) is usually designed within a range of phase values of 0 to 2π (rad), however, in the case of multiplying a correction coefficient α as described above, the phase values in the modulation pattern φ_{SLM}(x, y) obtained as a result may exceed the range of 0 to 2π (rad). Accordingly, as the spatial light modulator 20 used in the light modulation device 2A, it is preferable to use a modulator which is capable of expressing a phase whose position modulation amount exceeds a range of phase values set in normal CGH design.

Further, the light modulation method using a correction coefficient α as described above may be applied to stealth dicing laser processing of forming a modified layer by condensing laser light on the inside of an object such as silicon. In such laser processing, spherical aberration is caused by refractive-index mismatching, and the deeper the light condensing position is, the higher the influence by aberration is. Then, it has been proposed to carry out a correction of spherical aberration by use of an SLM (for example, refer to Patent Document 1).

Here, in the above-described aberration correction, the deeper the processing depth is, the higher the spatial frequency of an aberration correction pattern is. In particular, a lens effect is given to the aberration correction pattern described in Patent Document 1 in order to reduce a spatial frequency. Therefore, a light condensing point of the corrected laser light is reconstructed at a position different from that of the zeroth-order light, and accordingly, there are two light condensing points of the undesired zeroth-order light and desired light condensing laser light, as a result, it is impossible to perform desired processing onto an object. In contrast, in the configuration in which a correction coefficient α is applied to a modulation pattern as described above, it is possible to perform laser processing under good conditions by reducing undesired zeroth-order light.

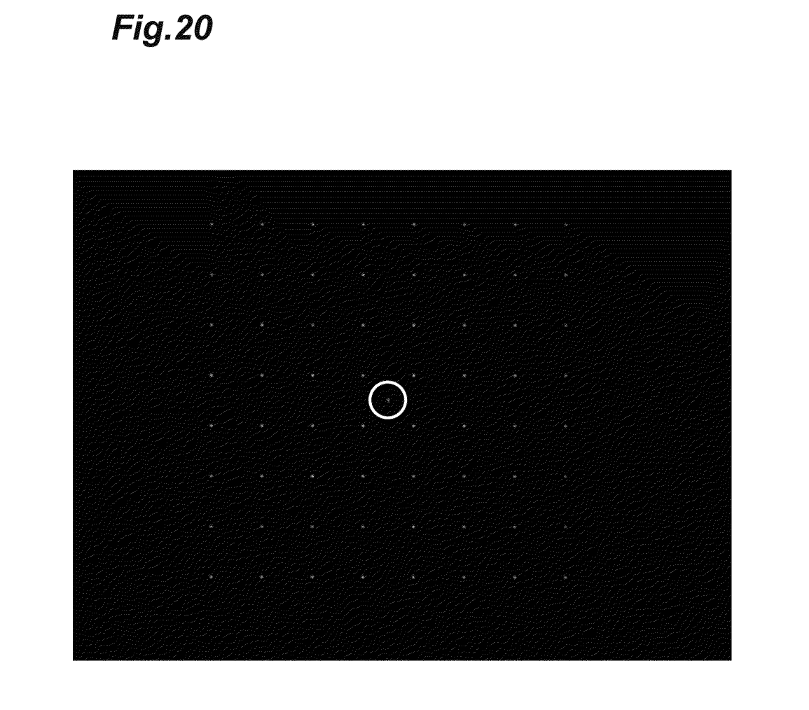

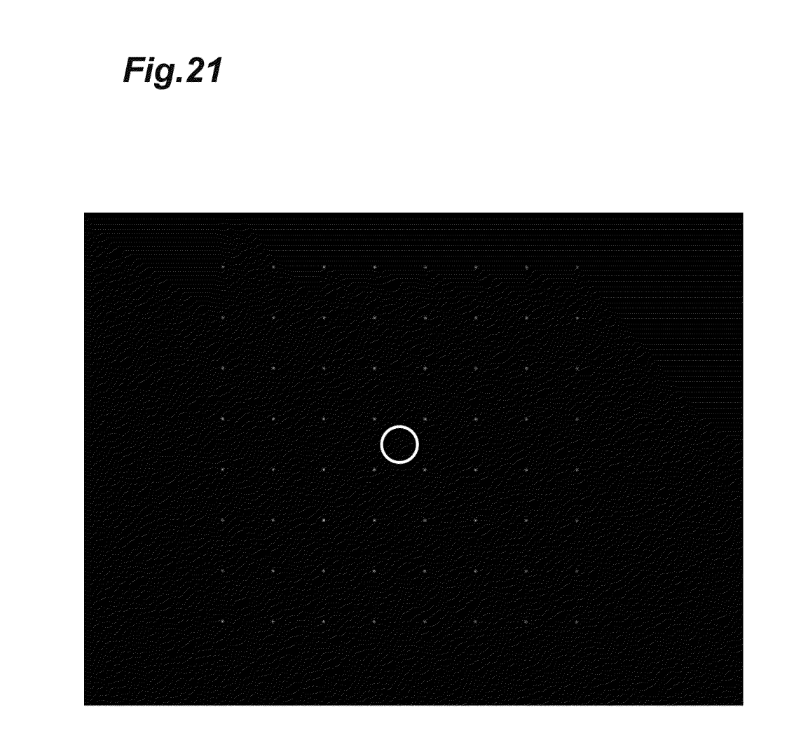

The suppression effect on undesired zeroth-order light from the SLM with a corrected modulation pattern using a coefficient α (α≧1) will be further described. FIG. 20 is a diagram showing a reconstruction result of a laser light irradiation pattern when a modulation pattern for reconstructing a rectangular multispot pattern with 8×8 points, which is created by use of the conventional CGH design method, is presented on the SLM. Further, FIG. 21 is a diagram showing a reconstruction result of a laser light irradiation pattern when a modulation pattern multiplied by a correction coefficient α by which the intensity of zeroth-order light is minimized by use of the method according to the present invention is presented on the SLM. In these FIGS. 20 and 21, the light condensing points respectively shown in a circle are undesired zeroth-order light components.

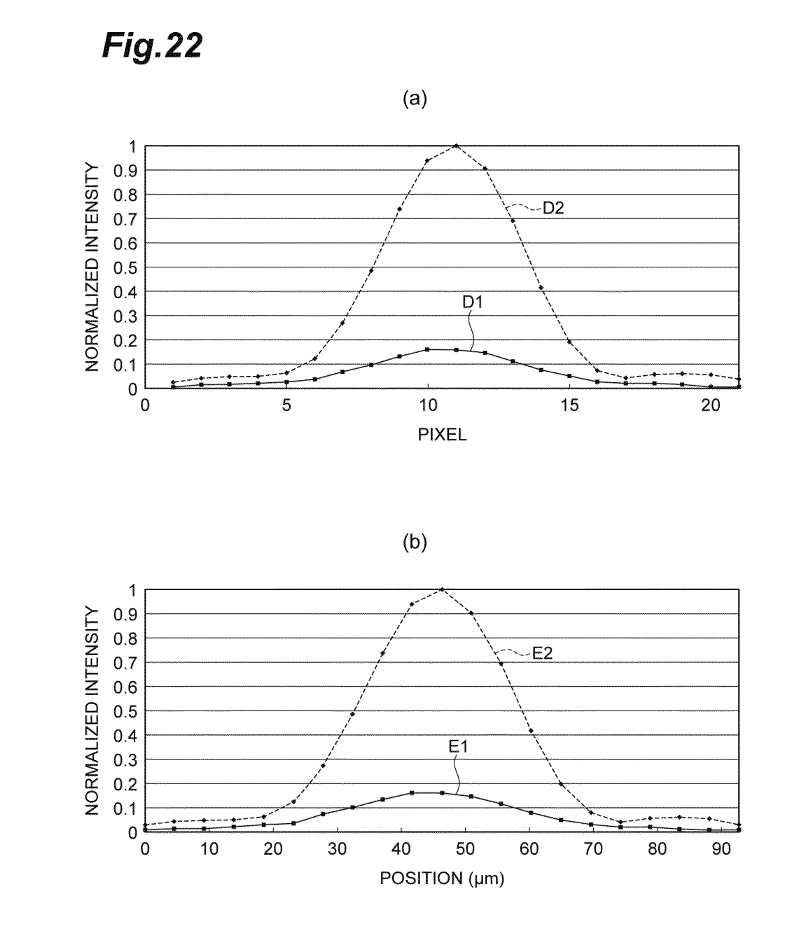

Further, FIG. 22 includes graphs showing the intensity profiles of the zeroth-order light in the reconstruction results shown in FIGS. 20 and 21. The intensity profiles of the zeroth-order light show one-dimensional profiles on the straight line passing through the central position in the light condensing patterns of the zeroth-order light. In the graph of (a) in FIG. 22, the horizontal axis shows the pixels, and the vertical axis shows the normalized light intensities. Further, in the graph of (b) in FIG. 22, the horizontal axis shows the positions (μm) converted from the pixels, and the vertical axis shows the normalized light intensities.

Here, an aperture is not disposed in front of a camera which is a photodetector, but a condenser lens of f=250 mm is used, to show the results obtained by an optical system which is equivalent to that of FIG. 15. In such a configuration, the 21 pixels on the camera correspond to an actual distance of 93 μm. Further, in (a) and (b) in FIG. 22, respectively, the graphs D1 and E1 show the intensity profiles of the zeroth-order light in the reconstruction result according to the present invention shown in FIG. 21, and further, the graphs D2 and E2 show the intensity profiles of the zeroth-order light in the reconstruction result by the conventional method shown in FIG. 20. As is understood from the respective graphs in FIG. 22, by applying the method of the present invention of multiplying a correction coefficient α of a modulation pattern, the peak intensity of the undesired zeroth-order light is reduced to approximately ⅙.

With respect to the suppression effect on undesired zeroth-order light from the SLM with a corrected modulation pattern using a coefficient α, a result with a cylindrical lens pattern is shown as another example. Here, the cylindrical lens pattern can be expressed, for example, as follows.

φ_{c}(x,y)=π(y−y₀)²/λf

Here, in the above-described formula, λ is a wavelength of light input to the SLM, and f is a focal length of the lens.

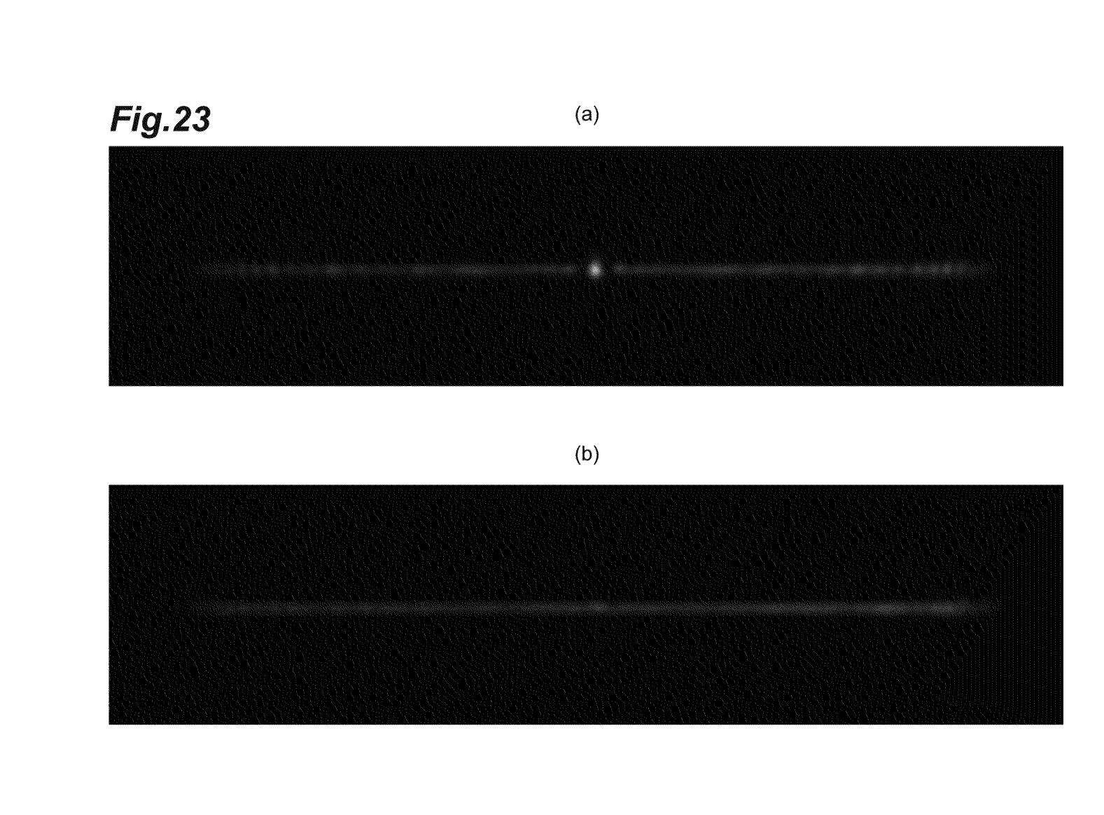

FIG. 23 includes diagrams showing the reconstruction results of the laser light irradiation patterns when a cylindrical lens pattern is presented on the SLM, (a) in FIG. 23 shows the reconstruction result of a laser light irradiation pattern when a conventional cylindrical lens pattern created by use of the above-described formula is presented on the SLM, and (b) in FIG. 23 shows the reconstruction result of a laser light irradiation pattern when a modulation pattern multiplied by a correction coefficient α is presented on the SLM.

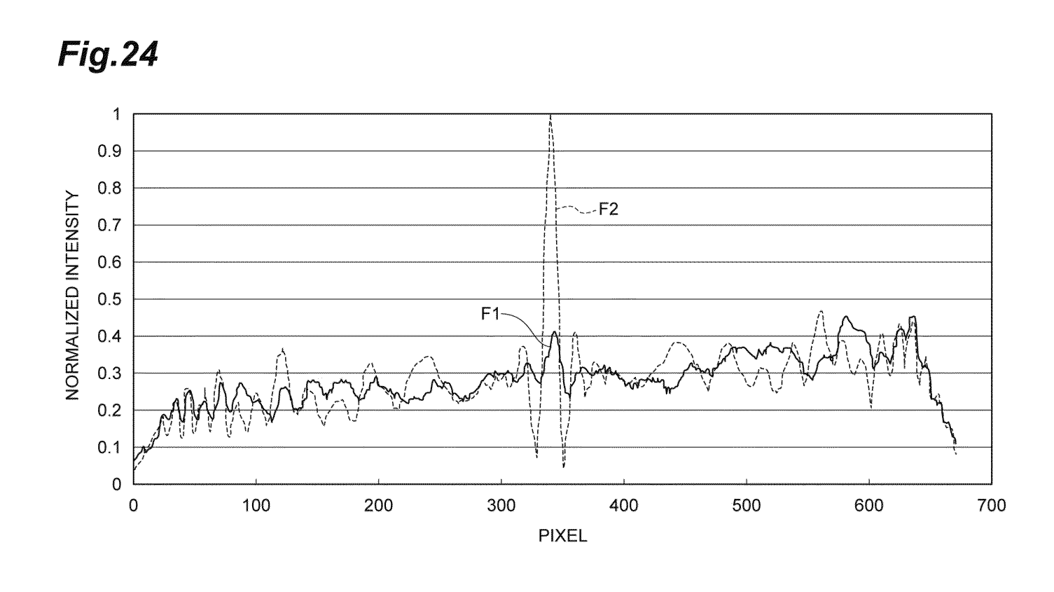

Further, FIG. 24 is a graph showing the intensity profiles of the zeroth-order light in the reconstruction results shown in (a) and (b) in FIG. 23. In the graph of FIG. 24, the horizontal axis shows the pixels, and the vertical axis shows the normalized light intensities. Further, in FIG. 24, the graph F1 shows the intensity profile of the zeroth-order light in the reconstruction result according to the present invention shown in (b) in FIG. 23, and further, the graph F2 shows the intensity profile of the zeroth-order light in the reconstruction result by the conventional method shown in (a) in FIG. 23. As is understood from the respective graphs in FIG. 24, the peak intensity of the undesired zeroth-order light is reduced to approximately 1/7 in this example using the cylindrical lens pattern as well.

The light modulation method, the light modulation program, the light modulation device, and the light irradiation device according to the present invention are not limited to the above-described embodiment and the configuration examples, and various modifications are possible. For example, the configuration of the entire optical system including the light modulation device, the light source, and the like is not limited to the configuration example shown in FIG. 1, and specifically, various configurations may be used. Further, setting of a correction coefficient α and correction of a modulation pattern using the correction coefficient α are carried out in the control device 30 in the configuration shown in FIG. 3, however, they are not limited to such a configuration, and for example, the configuration may be used in which setting of a correction coefficient α and correction of a modulation pattern are carried out in the driving device 28.

Further, as light serving as a modulation object by the spatial light modulator, laser light is mainly considered in the above-described embodiment, meanwhile, the present invention may be generally applied to light other than laser light. As such light, for example, coherent light output from a light source such as a laser light source, an LD, or an SLD, incoherent light output from a light source such as a lamp light source, and scattering light, fluorescence, and the like generated by laser light irradiation are included. Coherent light can be used for laser processing, for example. Further, light from a lamp light source, scattering light, fluorescence, and the like may be used for a microscope, or a light-receiving side of a laser ophthalmoscope, for example.

A light modulation method according to the above-described embodiment, (1) which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation method includes (2) a modulation pattern setting step of setting a target modulation pattern for modulating the phase of the light in the spatial light modulator, (3) a correction coefficient setting step of setting a correction coefficient α of α≧1 according to pixel structure characteristics of the spatial light modulator and pattern characteristics of the target modulation pattern, for the target modulation pattern, (4) a modulation pattern correction step of determining a corrected modulation pattern to be presented on the plurality of pixels of the spatial light modulator by multiplying the target modulation pattern by the correction coefficient α, and (5) a modulation pattern presentation step of presenting the corrected modulation pattern on the plurality of pixels of the spatial light modulator.

A light modulation program according to the above-described embodiment, (1) which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation program makes a computer execute (2) modulation pattern setting processing of setting a target modulation pattern for modulating the phase of the light in the spatial light modulator, (3) correction coefficient setting processing of setting a correction coefficient α of α≧1 according to pixel structure characteristics of the spatial light modulator and pattern characteristics of the target modulation pattern, for the target modulation pattern, (4) modulation pattern correction processing of determining a corrected modulation pattern to be presented on the plurality of pixels of the spatial light modulator by multiplying the target modulation pattern by the correction coefficient α, and (5) modulation pattern presentation processing of presenting the corrected modulation pattern on the plurality of pixels of the spatial light modulator.

A light modulation device according to the above-described embodiment includes (a) a phase-modulation type spatial light modulator having a plurality of two-dimensionally arrayed pixels, modulating a phase of input light for each pixel with a modulation pattern presented on the plurality of pixels, and outputting phase-modulated light, (b) modulation pattern setting means for setting a target modulation pattern for modulating the phase of the light in the spatial light modulator, (c) correction coefficient setting means for setting a correction coefficient α of α≧1 according to pixel structure characteristics of the spatial light modulator and pattern characteristics of the target modulation pattern, for the target modulation pattern, and (d) modulation pattern correction means for determining a corrected modulation pattern to be presented on the plurality of pixels of the spatial light modulator by multiplying the target modulation pattern by the correction coefficient α.

Here, with respect to setting of a correction coefficient, the light modulation method may use a configuration in which the correction coefficient α which is determined in advance according to the pattern characteristics so as to correspond to the target modulation pattern, to be stored in correction coefficient storage means is used, and the correction coefficient setting step sets the correction coefficient α according to a coefficient read out of the correction coefficient storage means. In the same way, the light modulation program may use a configuration in which the correction coefficient α which is determined in advance according to the pattern characteristics so as to correspond to the target modulation pattern, to be stored in the correction coefficient storage means is used, and the correction coefficient setting processing sets the correction coefficient α according to a coefficient read out of the correction coefficient storage means. In the same way, the light modulation device may use a configuration which includes correction coefficient storage means for storing the correction coefficient α which is determined in advance according to the pattern characteristics so as to correspond to the target modulation pattern, and the correction coefficient setting means sets the correction coefficient α according to a coefficient read out of the correction coefficient storage means.

In this way, pattern characteristics of a modulation pattern to be presented on the spatial light modulator are evaluated in advance, a coefficient α is determined according to the pattern characteristics, to be stored as coefficient data in the storage means, and the coefficient data is read out as needed, to be set as a correction coefficient α, thereby it is possible to appropriately set the correction coefficient α corresponding to the target modulation pattern.

Or, with respect to setting of a correction coefficient, the light modulation method may use a configuration which includes a correction coefficient derivation step of determining the correction coefficient α according to the pattern characteristics with reference to the target modulation pattern, and the correction coefficient setting step sets the correction coefficient α according to a coefficient determined by the correction coefficient derivation step. In the same way, the light modulation program may use a configuration which includes correction coefficient derivation processing of determining the correction coefficient α according to the pattern characteristics with reference to the target modulation pattern, and the correction coefficient setting processing sets the correction coefficient α according to a coefficient determined by the correction coefficient derivation processing. In the same way, the light modulation device may use a configuration which includes correction coefficient derivation means for determining the correction coefficient α according to the pattern characteristics with reference to the target modulation pattern, and the correction coefficient setting means sets the correction coefficient α according to a coefficient determined by the correction coefficient derivation means.

In this way, the pattern characteristics are evaluated with reference to the target modulation pattern which is set as a modulation pattern to be presented on the spatial light modulator, and a coefficient α is determined according to the pattern characteristics, to set the correction coefficient α, thereby it is also possible to appropriately set the correction coefficient α corresponding to the target modulation pattern.

Further, with respect to a correction coefficient, the light modulation method may be configured such that, in the correction coefficient setting step, the correction coefficient α is set as a coefficient α(x, y) for each pixel dependent on a two-dimensional pixel position of each of the plurality of pixels in the spatial light modulator. In the same way, the light modulation program may be configured such that, in the correction coefficient setting processing, the correction coefficient α is set as a coefficient α(x, y) for each pixel dependent on a two-dimensional pixel position of each of the plurality of pixels in the spatial light modulator. In the same way, the light modulation device may be configured such that, in the correction coefficient setting means, the correction coefficient α is set as a coefficient α(x, y) for each pixel dependent on a two-dimensional pixel position of each of the plurality of pixels in the spatial light modulator.

In the phase modulation pattern to be presented on the spatial light modulator, a case where a value of the correction coefficient α by which the modulation pattern is to be multiplied varies depending on a pixel position (x, y) in accordance with its specific pattern configuration may be considered. In contrast, with the configuration in which it is possible to set the correction coefficient α as a coefficient α(x, y) for each pixel as described above, it is possible to appropriately execute correction of the modulation pattern even in a case where a value of an optimum correction coefficient α is dependent on a pixel position.

Further, with respect to the pattern characteristics of the modulation pattern to be referenced in setting of a correction coefficient α, specifically, the light modulation method may be configured such that, in the correction coefficient setting step, a coefficient set according to spatial frequency characteristics of the target modulation pattern is used as the correction coefficient α. In the same way, the light modulation program may be configured such that, in the correction coefficient setting processing, a coefficient set according to spatial frequency characteristics of the target modulation pattern is used as the correction coefficient α. In the same way, the light modulation device may be configured such that, in the correction coefficient setting means, a coefficient set according to spatial frequency characteristics of the target modulation pattern is used as the correction coefficient α.

Or, with respect to the pattern characteristics of the modulation pattern to be referenced in setting of a correction coefficient, the light modulation method may be configured such that, in the correction coefficient setting step, a coefficient set according to a point having a maximum diffraction angle in a reconstructed pattern of light phase-modulated with the target modulation pattern is used as the correction coefficient α. In the same way, the light modulation program may be configured such that, in the correction coefficient setting processing, a coefficient set according to a point having a maximum diffraction angle in a reconstructed pattern of light phase-modulated with the target modulation pattern is used as the correction coefficient α. In the same way, the light modulation device may be configured such that, in the correction coefficient setting means, a coefficient set according to a point having a maximum diffraction angle in a reconstructed pattern of light phase-modulated with the target modulation pattern is used as the correction coefficient α. Further, in this case, in setting of a correction coefficient particularly, a coefficient set according to a distance between the point having the maximum diffraction angle in the reconstructed pattern of the light phase-modulated with the target modulation pattern and a light condensing point of zeroth-order light is preferably used as the correction coefficient α.

The light irradiation device according to the above-described embodiment includes a light source which supplies light serving as a modulation object, and a light modulation device having the above-described configuration including a phase-modulation type spatial light modulator which modulates a phase of the light supplied from the light source, and outputs the phase-modulated light. Further, in the case where the light serving as a modulation object is laser light, the laser light irradiation device includes a laser light source which supplies laser light, and a light modulation device having the above-described configuration including a phase-modulation type spatial light modulator which modulates a phase of the laser light supplied from the laser light source, and outputs the phase-modulated laser light.

In accordance with such a configuration, in the light modulation device including the phase-modulation type spatial light modulator, a modulation pattern corrected by multiplying the target modulation pattern by the correction coefficient α is presented on the plurality of pixels of the spatial light modulator, thereby it is possible to suppress the generation of undesired zeroth-order light in phase modulation of light, and it is possible to appropriately achieve operations such as irradiation of light onto an object with a desired irradiation pattern, and processing, observation, etc. of the object by the irradiation. Such a light irradiation device is available as, for example, a laser processing device, a laser microscope, a laser manipulation device, or an aberration correction device for a laser scanning ophthalmoscope or the like.

### INDUSTRIAL APPLICABILITY

The present invention is available as a light modulation method, a light modulation program, a light modulation device, and a light irradiation device which are capable of suppressing the generation of undesired zeroth-order light by an SLM.

### REFERENCE SIGNS LIST

1A—laser light irradiation device (light irradiation device), 2A—light modulation device, 10—laser light source, 11—beam expander, 12, 13—reflecting mirror, 20—spatial light modulator (SLM), 28—light modulator driving device, 30—light modulation control device, 50—irradiation object, 51, 52—4f optical system lens, 53—objective lens, 58—movable stage,
21—silicon substrate, 22—liquid crystal layer, 22a—liquid crystal molecule, 23—pixel electrode group, 23a—pixel electrode, 24—electrode, 25—glass substrate, 26—spacer,
31—target modulation pattern setting unit, 32—correction coefficient setting unit, 33—correction coefficient storage unit, 34—correction coefficient derivation unit, 35—modulation pattern correction unit, 36—light modulator drive control unit, 37—input device, 38—display device.

1: A light modulation method which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation method comprising:
a modulation pattern setting step of setting a target modulation pattern for modulating the phase of the light in the spatial light modulator;
a correction coefficient setting step of setting a correction coefficient α of α≧1 according to pixel structure characteristics of the spatial light modulator and pattern characteristics of the target modulation pattern, for the target modulation pattern;
a modulation pattern correction step of determining a corrected modulation pattern to be presented on the plurality of pixels of the spatial light modulator by multiplying the target modulation pattern by the correction coefficient α; and
a modulation pattern presentation step of presenting the corrected modulation pattern on the plurality of pixels of the spatial light modulator.

2: The light modulation method according to claim 1, wherein the correction coefficient α which is determined in advance according to the pattern characteristics so as to correspond to the target modulation pattern, to be stored in correction coefficient storage means is used, and
the correction coefficient setting step sets the correction coefficient α according to a coefficient read out of the correction coefficient storage means.

3: The light modulation method according to claim 1, comprising a correction coefficient derivation step of determining the correction coefficient α according to the pattern characteristics with reference to the target modulation pattern, wherein
the correction coefficient setting step sets the correction coefficient α according to a coefficient determined by the correction coefficient derivation step.

4: The light modulation method according to claim 1, wherein, in the correction coefficient setting step, the correction coefficient α is set as a coefficient α(x, y) for each pixel dependent on a two-dimensional pixel position of each of the plurality of pixels in the spatial light modulator.

5: The light modulation method according to claim 1, wherein, in the correction coefficient setting step, a coefficient set according to spatial frequency characteristics of the target modulation pattern is used as the correction coefficient α.

6: The light modulation method according to claim 1, wherein, in the correction coefficient setting step, a coefficient set according to a point having a maximum diffraction angle in a reconstructed pattern of light phase-modulated with the target modulation pattern is used as the correction coefficient α.

7: A light modulation program which uses a phase-modulation type spatial light modulator having a plurality of two-dimensionally arrayed pixels, modulating a phase of input light for each pixel with a modulation pattern presented on the plurality of pixels, and outputting phase-modulated light, the light modulation program makes a computer execute:
modulation pattern setting processing of setting a target modulation pattern for modulating the phase of the light in the spatial light modulator;
correction coefficient setting processing of setting a correction coefficient α of α≧1 according to pixel structure characteristics of the spatial light modulator and pattern characteristics of the target modulation pattern, for the target modulation pattern;
modulation pattern correction processing of determining a corrected modulation pattern to be presented on the plurality of pixels of the spatial light modulator by multiplying the target modulation pattern by the correction coefficient α; and
modulation pattern presentation processing of presenting the corrected modulation pattern on the plurality of pixels of the spatial light modulator.

8: The light modulation program according to claim 7, wherein the correction coefficient α which is determined in advance according to the pattern characteristics so as to correspond to the target modulation pattern, to be stored in correction coefficient storage means is used, and
the correction coefficient setting processing sets the correction coefficient α according to a coefficient read out of the correction coefficient storage means.

9: The light modulation program according to claim 7, comprising correction coefficient derivation processing of determining the correction coefficient α according to the pattern characteristics with reference to the target modulation pattern, wherein
the correction coefficient setting processing sets the correction coefficient α according to a coefficient determined by the correction coefficient derivation processing.

10: The light modulation program according to claim 7, wherein, in the correction coefficient setting processing, the correction coefficient α is set as a coefficient α(x, y) for each pixel dependent on a two-dimensional pixel position of each of the plurality of pixels in the spatial light modulator.

11: The light modulation program according to claim 7, wherein, in the correction coefficient setting processing, a coefficient set according to spatial frequency characteristics of the target modulation pattern is used as the correction coefficient α.

12: The light modulation program according to claim 7, wherein, in the correction coefficient setting processing, a coefficient set according to a point having a maximum diffraction angle in a reconstructed pattern of light phase-modulated with the target modulation pattern is used as the correction coefficient α.

13: A light modulation device comprising:
a phase-modulation type spatial light modulator having a plurality of two-dimensionally arrayed pixels, modulating a phase of input light for each pixel with a modulation pattern presented on the plurality of pixels, and outputting phase-modulated light;
modulation pattern setting means setting a target modulation pattern for modulating the phase of the light in the spatial light modulator;
correction coefficient setting means setting a correction coefficient α of α≧1 according to pixel structure characteristics of the spatial light modulator and pattern characteristics of the target modulation pattern, for the target modulation pattern; and
modulation pattern correction means determining a corrected modulation pattern to be presented on the plurality of pixels of the spatial light modulator by multiplying the target modulation pattern by the correction coefficient α.

14: The light modulation device according to claim 13, comprising correction coefficient storage means storing the correction coefficient α which is determined in advance according to the pattern characteristics so as to correspond to the target modulation pattern, wherein
the correction coefficient setting means sets the correction coefficient α according to a coefficient read out of the correction coefficient storage means.

15: The light modulation device according to claim 13, comprising correction coefficient derivation means determining the correction coefficient α according to the pattern characteristics with reference to the target modulation pattern, and
the correction coefficient setting means sets the correction coefficient α according to a coefficient determined by the correction coefficient derivation means.

16: The light modulation device according to claim 13, wherein, in the correction coefficient setting means, the correction coefficient α is set as a coefficient α(x, y) for each pixel dependent on a two-dimensional pixel position of each of the plurality of pixels in the spatial light modulator.

17: The light modulation device according to claim 13, wherein, in the correction coefficient setting means, a coefficient set according to spatial frequency characteristics of the target modulation pattern is used as the correction coefficient α.

18: The light modulation device according to claim 13, wherein, in the correction coefficient setting means, a coefficient set according to a point having a maximum diffraction angle in a reconstructed pattern of light phase-modulated with the target modulation pattern is used as the correction coefficient α.

19: A light irradiation device comprising:
a light source which supplies light; and
the light modulation device according to claim 13 which includes the phase-modulation type spatial light modulator modulating a phase of the light supplied from the light source, and outputting the phase-modulated light.
